(19) United States
(12) Patent Application Publication
(10) Pub. No.: US 2025/0380707 A1
(43) Pub. Date: Dec. 18, 2025

(54) AN AGRICULTURAL COMPOSITION

(71) Applicant: NATURAL PLANT PROTECTION LIMITED, MUMBAI (IN)

(72) Inventors: Dhirendra KUMAR, Mumbai (IN); Rekha PUTTASWAMY, Mumbai (IN); Jayalakshmi PALAKURI, Mumbai (IN)

(21) Appl. No.: 18/877,454

(22) PCT Filed: Jun. 27, 2023
(86) PCT No.: PCT/IN2023/050622

§ 371 Date: Dec. 20, 2024

(30) Foreign Application Priority Data
Jun. 27, 2022 (IN) 202221036778

(51) Int. Cl. A01N 65/08; A01N 25/22; A01N 63/22; A01N 63/25; A01N 63/27; A01N 63/28; A01N 63/30; A01P 21/00

(52) U.S. Cl. CPC A01N 65/08; A01N 25/22; A01N 63/22; A01N 63/25; A01N 63/27; A01N 63/28; A01N 63/30; A01P 21/00

(57) ABSTRACT

The present disclosure pertains to technical field of agricultural composition. In particular, the present disclosure pertains to an agriculturally beneficial composition comprising an agriculturally beneficial agent and an extract of plant belonging to Dodonaca genus, particularly, an extract of Dodonaca viscosa.

### TECHNICAL FIELD

The present disclosure pertains to the technical field of an agricultural composition comprising a plant extract. In particular, the present disclosure pertains to an agriculturally beneficial composition comprising an agriculturally beneficial agent and a plant extract.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

Agrochemical composition development has now emerged as an established technology, which is not only adding significant value to the formulators but also presenting the attractive products to users by improving the operator safety, reducing the dose rate along with wastage of agrochemical agents applied to crops, thereby improving environmental quality. Lowering the dose of chemical component and reduction in fertilizer component is an attractive proposition in lowering costs and chemical usage. However, such formulations are often met with lower efficacies. Thus, conventional compositions are still suffering from certain drawbacks such as increased dose rate or repeated applications to get desired bio-efficacy, toxicity, poor absorbability, limited mode of application, stability, and effectiveness in increasing crop production without compromising the quality of the crop.

Parallelly, innovations around this field are being targeted towards more sustainable alternatives such as natural extracts, environment friendly, safe, and decomposable ingredients which provide targeted solutions with no or minimal harm. Use of bacteria and fungi such as mycorrhiza are gaining popularity due to its numerous benefits for the plant and ecosystems.

Nutrient solubilizing bacteria such as potassium solubilizing bacteria, phosphate solubilizing bacteria, nitrogen assimilating bacteria aid in plant growth by solubilizing and assimilating inorganic nutrients from their insoluble forms and making them bioavailable for plant uptake. Although many compositions have been developed to formulate these bacteria, the issue of sustainable viability of the living microbes and resulting loss of efficacy is a persistent cause for concern.

Mycorrhizae (mycorrhiza) are fungi which colonize the host plant's root tissues, either intracellularly as in arbuscular mycorrhizal fungi (AMF or AM), or extracellularly as in ectomycorrhizal fungi. The association is mutualistic. Mycorrhizas are commonly divided into ectomycorrhizas and endomycorrhizas. The two types are differentiated by the fact that the hyphae of ectomycorrhizal fungi do not penetrate individual cells within the root, while the hyphae of endomycorrhizal fungi penetrate the cell wall and invaginate the cell membrane. An unresolved problem plaguing the mycorrhizal formulations is viability and survivability of mycorrhiza and loss in efficacy over time.

There is, therefore, an unmet need in the art for a new and improved agriculturally beneficial composition that exhibits improved stability and shelf-life of living micro-organisms while being effective in increasing plant vigor and growth. There is also a need for sustainable solutions which is natural, environment friendly and safe for plants and ecosystems. There is yet another need for agricultural compositions which give higher efficacy with reduced dosage of chemical or fertilizer. The present invention satisfies the existing needs, as well as others, and generally overcomes the deficiencies found in the state of art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### OBJECTS OF THE INVENTION

It is an object of the present disclosure to overcome the problems associated with the existing agricultural compositions comprising live micro-organisms.

It is another object of the present disclosure to provide an agriculturally beneficial composition with an improved shelf-life and stability.

It is another object of the present disclosure to provide an agriculturally beneficial composition that provides good plant growth, improved quality of product with higher yield.

It is another object of the present disclosure to provide an agriculturally beneficial composition that is economical.

It is another object of the present disclosure to provide an agriculturally beneficial composition that is safe for plants and environment.

It is another object of the present disclosure to provide an agriculturally beneficial composition that is easy to prepare.

Yet another object of the present disclosure is to provide a method of preparation of an agriculturally beneficial composition.

### SUMMARY

The present disclosure pertains to the technical field of an agricultural composition comprising a plant extract. In particular, the present disclosure pertains to an agriculturally beneficial composition comprising an agriculturally beneficial agent and an extract of a plant belonging to Dodonaea genus. In one embodiment, the agriculturally beneficial composition comprises an agriculturally beneficial agent and an extract of Dodonaea viscosa.

An aspect of the present disclosure provides an agricultural composition, the composition comprising: one or more agriculturally beneficial agents and an extract of a plant belonging to Dodonaea genus. The extract of a plant belonging to Dodonaea genus may act as a gelling agent or a binding agent in said agrochemical composition.

In an embodiment, the agriculturally beneficial agents are selected from agrochemical agents, biological agents, and combinations thereof.

In an embodiment, the agrochemical agents are selected from an herbicide, a fungicide, an insecticide, a micronutrient, a fertilizer, and combinations thereof.

In an embodiment, the biological agents are selected from bacteria, mycorrhizal fungi, and a combination thereof. In an embodiment, the mycorrhizal fungus comprises mycorrhizal propagules. In an embodiment, the mycorrhizal propagules are selected from propagules of endomycorrhiza, propagules of ectomycorrhiza, and combinations thereof.

An aspect of the present disclosure provides an agricultural composition, the composition comprising: mycorrhizal propagules and an extract of a plant belonging to Dodonaea genus. In an embodiment, the present disclosure provides an agricultural composition comprising mycorrhizal propagules and an extract of Dodonaea viscosa.

In an embodiment, the Dodonaea plant extract acts as a gelling agent or a binding agent.

In an embodiment, the combinations or the compositions of the present disclosure may further be mixed with or applied in conjunction with other agrochemically active ingredients or composition(s) comprising other agrochemically active ingredients. The other agrochemically active ingredients may be selected from fertilizers, micronutrients, acaricides, algicides, antifeedants, avicides, bactericides, bird repellents, chemosterilants, fungicides, herbicide safeners, herbicides, insect attractants, insect repellents, insecticides, mammal repellents, mating disruptors, molluscicides, nematicides, plant activators, plant-growth regulators, rodenticides, synergists, virucides, derivatives thereof, biological control agents or mixtures thereof. The said mixtures may be premixed compositions or may be tank mixed at the time of application. The combinations or the compositions of the present disclosure may be applied with the other agrochemically active ingredients jointly or separately in a sequential manner.

In an embodiment, the other agrochemically active ingredient is selected from the group consisting of insecticides, fungicides, biostimulants, and combinations thereof.

An aspect of the present disclosure also provides a method of preparing an extract extract of a plant belonging to Dodonaea genus comprising:
A. grinding leaves, stems, roots and/or other parts of a plant belonging to Dodonaea genus into small particles, grains or a powder;
B. mixing the powder obtained in step A with a solvent and stirring to obtain a suspension;
C. adding a buffer salt mixture to the suspension obtained in step B;
D. centrifuging the suspension of step C and separating the supernatant to obtain the extract of a plant belonging to Dodonaea genus.

An aspect of the present disclosure also provides an extract of a plant belonging to Dodonaea genus prepared by the above-mentioned process.

Further aspect of the present disclosure relates to a method of preparation of an agriculturally beneficial composition.

Another aspect of the present disclosure provides a method of improving plant health comprising applying to the plant, plant propagation material, site of plant growth, soil or a locus an agricultural composition comprising an agriculturally beneficial agent (e.g., mycorrhizal propagules, bacteria, herbicides, etc.) and an extract of a plant belonging to Dodonaea genus.

In an embodiment, the method of improving plant health comprises applying to the plant, plant propagation material, site of plant growth, soil, or a locus an agricultural composition comprising mycorrhizal propagules and an extract of a plant belonging to Dodonaea genus. In an embodiment, the method of improving plant health comprises applying to the plant, plant propagation material, site of plant growth, soil, or a locus an agricultural composition comprising mycorrhizal propagules and an extract of Dodonaea viscosa.

In an embodiment, the present disclosure provides a method of treating a seed of a plant comprising applying the agricultural composition comprising an agriculturally beneficial agent (e.g., mycorrhizal propagules, bacteria, herbicides, etc.) and an extract of a plant belonging to Dodonaea genus to the seed. In an embodiment, the method comprises applying an agricultural composition comprising mycorrhizal propagules and an extract of Dodonaea viscosa to the seed.

An aspect of the present disclosure also provides a use of an agricultural composition comprising mycorrhizal propagules and an extract of a plant belonging to Dodonaea genus for improving plant health and seed treatment.

Various objects, features, aspects, and advantages of the inventive subject matter will become more apparent from the following detailed description of preferred embodiments.

### DETAILED DESCRIPTION OF THE INVENTION

The following is a detailed description of embodiments of the present invention. The embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability.

Unless the context requires otherwise, throughout the specification which follow, the word “comprise” and variations thereof, such as, “comprises”, “comprising”, “includes” and “including” are to be construed in an open, inclusive sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

In some embodiments, the numbers expressing quantities of ingredients, properties such as concentration, and so forth, used to describe and claim certain embodiments of the invention are to be understood as being modified in some instances by the term “about.” Accordingly, in some embodiments, the numerical parameters set forth in the written description are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The recitation of ranges of values herein is merely intended to serve as a shorthand method of referring individually to each separate value falling within the range. Unless otherwise indicated herein, each individual value is incorporated into the specification as if it were individually recited herein.

The headings and abstract of the disclosure provided herein are for convenience only and do not interpret the scope or meaning of the embodiments.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illustrate the invention and does not pose a limitation on the scope of the invention otherwise claimed. No language in the specification should be construed as indicating any non-claimed element essential to the practice of the invention.

The following discussion provides many exemplary embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

Various terms as used herein are described below. To the extent a term used in a claim is not defined below, it should be given the broadest definition persons in the pertinent art have given that term as reflected in printed publications and issued patents at the time of filing.

The term “about” as used herein encompasses variations of +/−10% and more preferably +/−5%, as such variations are appropriate for practicing the present invention.

An embodiment of the present disclosure provides an agricultural composition comprising one or more agriculturally beneficial agents and an extract of a plant belonging to Dodonaea genus.

In an embodiment, the extract of the plant belonging to Dodonaea genus acts as a gelling agent or a binding agent in said agrochemical composition.

In an embodiment, one or more agriculturally beneficial agents are present in an amount ranging from about 0.1% to about 90% by weight of the composition. In an embodiment, one or more agriculturally beneficial agents are present in an amount ranging from about 1% to about 70% by weight of the composition. In an embodiment, one or more agriculturally beneficial agents are present in an amount ranging from about 5% to about 50% by weight of the composition.

In an embodiment, one or more agriculturally beneficial agents are present in an amount ranging from about 10% to about 30% by weight of the composition. In an embodiment, one or more agriculturally beneficial agents are present in an amount ranging from about 5% to about 40%, about 5% to about 35%, about 5% to about 30%, about 5% to about 25%, about 5% to about 20%, about 10% to about 40%, about 10% to about 35%, about 10% to about 25%, about 10% to about 20%, about 15% to about 45%, about 15% to about 40%, about 15% to about 35%, about 15% to about 30%, about 20% to about 40%, about 25% to about 50%, about 25% to about 45%, or about 30% to about 50%, by weight of the composition.

The term “Dodonaea genus” includes all species of the genus Dodonaea that are known to a person skilled in the art.

In an embodiment, the plant belonging to Dodonaea genus is selected from the group consisting of Dodonaea triquetra, Dodonaea triangularis, Dodonaea lanceolata, Dodonaea serratifolia, Dodonaea trifida, Dodonaea bursariifolia, Dodonaea amblyophylla, Dodonaea humifusa, Dodonaea ceratocarpa, Dodonaea pinifolia, Dodonaea ericoides, Dodonaeaivaricata, Dodonaea caespitosa, Dodonaea tepperi, Dodonaea hexandra, Dodonaea stenophylla, Dodonaea pachyneura, Dodonaea rigidia, Dodonaea baueri, Dodonaea platyptera, Dodonaea adenophora, Dodonaea microzyga, Dodonaea polyzyga, Dodonaea physocarpa, Dodonaea madagascariensis, Dodonaea stenozyga, Dodonaea polyandra, Dodonaea concinna, Dodonaea larreoides, Dodonaea vestita, Dodonaea procumbens, Dodonaea biloba, Dodonaea viscosa, Dodonaea camfieldii, Dodonaea rupicola, Dodonaea boroniifolia, Dodonaea pinnata, Dodonaea multijuga, Dodonaea filiformis, Dodonaea macrossanii, Dodonaea oxyptera, Dodonaea falcata, Dodonaea peduncularis, Dodonaea filifolia, Dodonaea uncinata, Dodonaea hackettiana, Dodonaea coriacea, Dodonaea hirsuta, Dodonaea truncatiales, Dodonaea rhombifolia, Dodonaea megazyga, Dodonaea tenuifolia, Dodonaea heteromorpha, Dodonaea inaequifolia, Dodonaea ptarmicaefolia, Dodonaea lobulata, Dodonaea aptera, Dodonaea intricata, Dodonaea sinuolata, and combinations thereof.

In an embodiment, the plant belonging to Dodonaea genus is Dodonaea viscosa. Although, in some embodiments, the agricultural composition of the present disclosure employs an extract of Dodonaea viscosa, an extract obtained from other species of the Dodonaea genus may be employed in some other embodiments. Leaves, stems, seeds, roots or any other plant part of Dodonaea viscosa may be suitable for preparation of the extract. Dodonaea viscosa is a species of flowering plant in the soapberry family, Sapindaceae that has a cosmopolitan distribution in tropical, subtropical and warm temperate regions of Africa, the Americas, southern Asia and Australia. During extensive experimentation, it was observed that an extract of Dodonaea, such as an aqueous extract of Dodonaea viscosa, includes a significant proportion of natural polymers and hence, may serve as a source of low-cost polysaccharides. Further, it was observed that an extract of Dodonaea, such as an aqueous extract of Dodonaea viscosa has a high water holding capacity and hence, may also aid in supporting or promoting the overall plant health and vigor.

In an embodiment, the extract of the plant belonging to Dodonaea genus is an aqueous extract.

In an embodiment, the extract of the plant belonging to Dodonaea genus is a solvent.

In an embodiment, the composition comprises the extract of the plant belonging to Dodonaea genus in an amount ranging from about 0.1% to about 40% by weight of the composition. In an embodiment, the composition includes the extract of the plant belonging to Dodonaea genus in an amount ranging from about 0.3% to about 30% by weight of the composition. In an embodiment, the composition includes the extract of the plant belonging to Dodonaea genus in an amount ranging from about 0.5% to about 20% by weight of the composition. In an embodiment, the composition includes the extract of the plant belonging to Dodonaea genus in an amount ranging from about 0.1% to about 30%, about 0.1% to about 25%, about 0.1% to about 20%, about 0.1% to about 15%, about 0.1% to about 10%, about 0.3% to about 25%, about 0.3% to about 20%, about 0.3% to about 15%, about 0.3% to about 10%, about 0.5% to about 40%, about 0.5% to about 30%, about 0.5% to about 25%, about 0.5% to about 15%, about 0.5% to about 10%, about 1% to about 40%, about 1% to about 30%, about 1% to about 25%, about 1% to about 20%, about 1% to about 15%, about 1% to about 10%, bout 2% to about 40%, about 2% to about 35%, about 2% to about 30%, about 2% to about 25%, about 2% to about 20%, about 2% to about 15%, about 2% to about 10%, about 5% to about 40%, about 5% to about 35%, about 5% to 30%, about 5% to about 20%, about 5% to about 15%, about 10% to about 40%, about 10% to about 35%, about 10% to about 30%, about 15% to about 30%, or about 20% to about 40%, by weight of the composition.

In an embodiment, the one or more agriculturally beneficial agents are selected from agrochemical agents, biological agents, and combinations thereof.

In an embodiment, the agrochemical agents are selected from an herbicide, a fungicide, an insecticide, a micronutrient, a fertilizer, and combinations thereof.

In an embodiment, the herbicide is selected from one or more of amide herbicides, anilide herbicides, arylalanine herbicides, chloroacetanilide herbicides, sulfonanilide herbicides, sulfonamide herbicides, sulfonylurea herbicides, thioamide herbicides, aromatic acid herbicides, benzoic acid herbicides, pyrimidinyloxybenzoic acid herbicides, pyrimidinylthiobenzoic acid herbicides, phthalic acid herbicides, picolinic acid herbicides, quinolinecarboxylic acid herbicides, aroylcyclohexanedione herbicides, arsenical herbicides, benzofuranyl alkylsulfonate herbicides, benzothiazole herbicides, carbamate herbicides, carbanilate herbicides, carbonate herbicides, cyclohexene oxime herbicides, cyclopropylisoxazole herbicides, dicarboximide herbicides, uracil herbicides, dinitroaniline herbicides, dinitrophenol herbicides, diphenyl ether herbicides, nitrophenyl ether herbicides, dithiocarbamate herbicides, fumigant herbicides, halogenated aliphatic herbicides, imidazolinone herbicides, imide herbicides, inorganic herbicides, nitrile herbicides, organophosphorus herbicides, oxadiazolone herbicides, oxazole herbicides, phenoxy herbicides, phenoxyacetic herbicides, phenoxybutyric herbicides, phenoxypropionic herbicides, aryloxyphenoxypropionic herbicides, phenylenediamine herbicides, pyrazole herbicides, benzoylpyrazole herbicides, phenylpyrazole herbicides, pyridazine herbicides, pyridazinone herbicides, pyridine herbicides, pyrimidinediamine herbicides, pyrimidinyloxybenzylamine herbicides, quaternary ammonium herbicides, thiocarbamate herbicides, thiocarbonate herbicides, thiourea herbicides, triazine herbicides, chlorotriazine herbicides, fluoroalkyltriazine herbicides, methoxytriazine herbicides, methylthiotriazine herbicides, triazinone herbicides, triazole herbicides, triazolone herbicides, triazolopyrimidine herbicides, uracil herbicides, phenyluracil herbicides, urea herbicides, phenylurea herbicides, pyrimidinylsulfonylurea herbicides, triazinylsulfonylurea herbicides, thiadiazolylurea herbicides and unclassified herbicides.

In an embodiment, the fungicide is selected from one or more of aliphatic nitrogen fungicides, amide fungicides, acylamino acid fungicides, anilide fungicides, benzanilide fungicides, furanilide fungicides, sulfonanilide fungicides, benzamide fungicides, furamide fungicides, phenylsulfamide fungicides, picolinamide fungicides, pyrazolecarboxamide fungicides, sulfonamide fungicides, valinamide fungicides, antibiotic fungicides, strobilurin fungicides, methoxyacrylate strobilurin fungicides, methoxycarbanilate strobilurin fungicides, methoxyiminoacetamide strobilurin fungicides, methoxyiminoacetate strobilurin fungicides, aromatic fungicides, arsenical fungicides, aryl phenyl ketone fungicides, benzimidazole fungicides, benzimidazole precursor fungicides, benzothiazole fungicides, botanical fungicides, bridged diphenyl fungicides, carbamate fungicides, benzimidazolylcarbamate fungicides, carbanilate fungicides, conazole fungicides, conazole fungicides (imidazoles), conazole fungicides (triazoles), copper fungicides, cyanoacrylate fungicides, dicarboximide fungicides, dichlorophenyl dicarboximide fungicides, phthalimide fungicides, dinitrophenol fungicides, dithiocarbamate fungicides, cyclic dithiocarbamate fungicides, polymeric dithiocarbamate fungicides, dithiolane fungicides, fumigant fungicides, hydrazide fungicides, imidazole fungicides, conazole fungicides (imidazoles), inorganic fungicides, copper fungicides, inorganic mercury fungicides, mercury fungicides, inorganic mercury fungicides, organomercury fungicides, morpholine fungicides, organophosphorus fungicides, organotin fungicides, oxathiin fungicides, oxazole fungicides, polysulfide fungicides, pyrazole fungicides, phenylpyrazole fungicides, pyrazolecarboxamide fungicides, pyridazine fungicides, pyridine fungicides, pyrimidine fungicides, anilinopyrimidine fungicides, pyrrole fungicides, quaternary ammonium fungicides, quinoline fungicides, quinone fungicides, quinoxaline fungicides, tetrazole fungicides, thiadiazole fungicides, thiazole fungicides, thiazolidine fungicides, thiocarbamate fungicides, thiophene fungicides, triazine fungicides, triazole fungicides, conazole fungicides (triazoles), triazolopyrimidine fungicides, urea fungicides, zinc fungicides, and unclassified fungicides.

In an embodiment, the insecticide is selected from one or more of arsenical insecticides, botanical insecticides, carbamate insecticides, benzofuranyl methylcarbamate insecticides, dimethylcarbamate insecticides, oxime carbamate insecticides, phenyl methylcarbamate insecticides, diamide insecticides, isoxazoline insecticides, meta-diamide insecticides, phthalamide ir dinitrophenol insecticides, fluorine insecticides, formamidine insecticides, fumigant insecticides, inorganic insecticides, arsenical insecticides, fluorine insecticides, insect growth regulators, unclassified insect growth regulators, isoxazoline insecticides, macrocyclic lactone insecticides, avermectin insecticides, milbemycin insecticides, spinosyn insecticides, mesoionic insecticides, meta-diamide insecticides, neonicotinoid insecticides, nitroguanidine neonicotinoid insecticides, nitromethylene neonicotinoid insecticides, pyridylmethylamine neonicotinoid insecticides, nereistoxin analogue insecticides, organochlorine insecticides, cyclodiene insecticides, organophosphorus insecticides, organophosphate insecticides, organothiophosphate insecticides, aliphatic organothiophosphate insecticides, aliphatic amide organothiophosphate insecticides, oxime organothiophosphate insecticides, heterocyclic organothiophosphate insecticides, benzothiopyran organothiophosphate insecticides, benzotriazine organothiophosphate insecticides, isoindole organothiophosphate insecticides, isoxazole organothiophosphate insecticides, phenylpyrazole organothiophosphate insecticides, pyrazolopyrimidine organothiophosphate insecticides, pyridine organothiophosphate insecticides, pyrimidine organothiophosphate insecticides, quinoxaline organothiophosphate insecticides, thiadiazole organothiophosphate insecticides, triazole organothiophosphate insecticides, phenyl organothiophosphate insecticides, phosphonate insecticides, phosphonothioate insecticides, phenyl ethylphosphonothioate insecticides, phenyl phenylphosphonothioate insecticides, phosphoramidate insecticides, phosphoramidothioate insecticides, phosphorodiamide insecticides, oxadiazine insecticides, oxadiazolone insecticides, phthalamide insecticides, phthalimide insecticides, physical insecticides, desiccant insecticides, pyrazole insecticides, phenylpyrazole insecticides, pyrazolecarboxamide insecticides, pyridylpyrazole insecticides, pyrethroid insecticides, pyrethroid ester insecticides, pyrethroid ether insecticides, pyrethroid oxime insecticides, pyrimidinamine insecticides, pyrrole insecticides, quaternary ammonium insecticides, sulfoximine insecticides, tetramic acid insecticides, tetronic acid insecticides, thiazole insecticides, thiazolidine insecticides, thiourea insecticides, urea insecticides, and unclassified insecticides.

In an embodiment, the biological agents are selected from bacteria, mycorrhizal fungi and a combination thereof.

In an embodiment, the biological agents are bacteria.

In an embodiment, the biological agents are mycorrhizal fungi.

In an embodiment, the biological agents are a combination of bacteria and mycorrhizal fungi.

In an embodiment, the biological agents are selected from the group consisting of Piriformospora indica, Pseudomonas fluorescens, Bacillus subtilis, Laccaria bicolor, Rhizophagus irregularis, Rhizophagus clarus, Gigaspora margarita, Scutellospora heterogama, Glomus mosseae, Pisolithus tinctorius, Laccaria laccata, Rhizopogon roseolus, Laccaria proxima, Bacillus aryabhattai, Rhizobium leguminosarum, Azorhizobium caulidans, Fraturia aurentia, Bacillus megaterium, Azotobacter chroococcum, Azospirilum lipoferum, Glucanoacetobacter diazotrophicus, Streptomyces viridochromogenes, Streptomyces hygroscopicus, Streptomyces koyangenesis, Streptomyces iarkyus, and combinations thereof.

In an embodiment, the bacteria are selected from a group consisting of Actinomyces, Streptomyces, Mycobacterium, Nocardia, Corynebacterium, Streptococcus, Staphylococcus, Mycoplasma, Ureoplasma, Veillonella, Bacillus, Clostridium, Lactobacillus, Listeria, Rickettsia, Burkholderia, Escherichia, Pseudomonas, Legionella, Vibrio, Enterobacter, Stenotrophomonas, Azospirillum, Azovibrio, Polyangium, Ramlibacter, Rubrivivax, Sphingomonas, Rhizobium, Amycolatopsis, Pseudonocardia, Sphingomonas, Massilia, Methylobacterium, Bradyrhizobium, Bosea, Paenibacillus, Borrelia, Treponema, Leptospira, Gluconacetobacter, Azotobacter and combinations thereof. In an embodiment, preferred bacteria are Bacillus, Azotobacter, Rhizobium, Gluconacetobacter, and Pseudomonas.

In an embodiment, the bacteria are selected from a group consisting of Pseudomonas fluorescens, Bacillus subtilis, Bacillus aryabhattai, Rhizobium leguminosarum, Azorhizobium caulidans, Fraturia aurentia, Bacillus megaterium, Azotobacter chroococcum, Azospirilum lipoferum, Glucanoacetobacter diazotrophicus, Streptomyces viridochromogenes, Streptomyces hygroscopicus, Streptomyces koyangenesis, Streptomyces iarkyus, and combinations thereof. In an embodiment, preferred bacteria are Pseudomonas fluorescens, Bacillus subtilis, Rhizobium leguminosarum, Bacillus megaterium, Azotobacter chroococcum, Gluconacetobacter diazotrophicus, and combinations thereof.

In an embodiment, the mycorrhizal fungi are endomycorrhiza or ectomycorrhiza. In an embodiment, the mycorrhizal fungi are endomycorrhiza or spores or propagules thereof, ectomycorrhiza or spores or propagules thereof, or combinations thereof. Endomycorrhiza and ectomycorrhiza are biologically symbiotic soil fungi, which colonize plant root systems and act as a living extension of the roots, increasing the absorptive surface area and improving the plant nutrient and water efficiency. Through this symbiosis, endomycorrhiza and/or ectomycorrhiza offers direct and indirect benefits to host plants such as, but not limited to, stress resilience, drought resistance, and reduction in the fertilizer and irrigation requirements.

In an embodiment, the mycorrhizal fungi comprise mycorrhizal propagules. In an embodiment, the mycorrhizal propagules are selected from propagules of endomycorrhiza, propagules of ectomycorrhiza and combinations thereof.

In an embodiment, the mycorrhizal propagules comprise propagules of endomycorrhiza selected from arbuscular mycorrhiza, ericoid mycorrhiza, arbutoid mycorrhiza, monotropoid mycorrhiza, orchid mycorrhiza, or combinations thereof.

In an embodiment, the mycorrhizal propagules comprise propagules of endomycorrhiza selected from the class Glomeromycota (glomeromycetes). In an embodiment, the mycorrhizal propagules of the class Glomeromycota are selected from the order Archaeosporales, Diversisporales, Glomerales, Paraglomerales or combinations thereof.

In an embodiment, the mycorrhizal propagules comprise propagules of Glomaceae (Glomeraceae), Acaulosporaceae, Archaeosporaceae, Diversisporaceae, Pacisporaceae, Paraglomaceae, Gigasporaceae, Ambisporaceae, Geosiphonaceae, Claroideoglomeraceae or combinations thereof. In an embodiment, the mycorrhizal propagules comprise propagules of Glomus genera, Entrophospora, Funneliformis, Rhizophagus, Septoglomus, Acaulospora, Archaeospora, Paraglomus, Gigaspora, Pacispora, Sclerocystis, Dentiscutata, Scutellospora, and combinations thereof.

In an embodiment, the mycorrhizal propagules comprise propagules of endomycorrhiza selected from a group comprising Rhizophagus irregularis, Rhizophagus clarus, Gigaspora margarita, Scutellospora heterogama, Glomus mossae, Septoglomus viscosum, Funneliformis mossae, and combinations thereof.

The term “Scutellospora heterogama” as used herein also refers to Dentiscutata heterogama and subspecies and strains thereof.

In an embodiment, the mycorrhizal propagules comprise propagules of endomycorrhiza selected from a group comprising Rhizophagus irregularis, Rhizophagus clarus, Gigaspora margarita, Scutellospora heterogama, and combinations thereof.

In an embodiment, the mycorrhizal propagules comprise a combination of propagules of endomycorrhiza. In an embodiment, the combination of mycorrhizal propagules comprises a combination of Rhizophagus irregularis, Rhizophagus clarus, Gigaspora margarita and Scutellospora heterogama. In some embodiments, the composition of the present disclosure comprises a combination of endomycorrhizal propagules selected from: (i) propagules of Rhizophagus irregularis and Rhizophagus clarus, (ii) propagules of Rhizophagus irregularis and Gigaspora margarita, (iii) propagules of Rhizophagus irregularis and Scutellospora heterogama, (iv) propagules of Rhizophagus clarus and Gigaspora margarita, (v) propagules of Rhizophagus clarus and Scutellospora heterogama, (vi) propagules of Gigaspora margarita and Scutellospora heterogama, (vii) propagules of Rhizophagus irregularis, Rhizophagus clarus, and Gigaspora margarita, (viii) propagules of Rhizophagus irregularis, Rhizophagus clarus, and Scutellospora heterogama, (ix) propagules of Rhizophagus irregularis, Gigaspora margarita and Scutellospora heterogama, and (x) propagules of Rhizophagus irregularis, Rhizophagus clarus, Gigaspora margarita and Scutellospora heterogama.

In an embodiment, the mycorrhizal propagules comprise propagules of ectomycorrhiza selected from Laccaria, Pisolithus, Piriformospora, Scleroderma, Rhizopogon, and combinations thereof.

In an embodiment, the mycorrhizal propagules comprise, but are not limited to, propagules of ectomycorrhiza selected from Piriformospora indica, Laccaria bicolor, Laccaria lacata, Rhizopogon roseolus, Laccaria proxima, Pisolithus arhizus and Pisolithus tinctorius. In an embodiment, the mycorrhizal propagules include a combination of propagules of ectomycorrhiza. In an embodiment, the combination of mycorrhizal propagules includes a combination of Piriformospora indica, Laccaria bicolor and Pisolithus tinctorius. In an embodiment, the combination of mycorrhizal propagules includes a combination of Piriformospora indica, Laccaria bicolor, Laccaria lacata and Pisolithus tinctorius. In some embodiments, the composition of the present disclosure comprises a combination of ectomycorrhizal propagules selected from: (i) propagules of Piriformospora indica and propagules of Laccaria bicolor, (ii) propagules of Piriformospora indica and propagules of Pisolithus tinctorius, (iii) propagules of Laccaria bicolor and propagules of Pisolithus tinctorius, (iv) propagules of Piriformospora indica, propagules of Laccaria bicolor, and propagules of Pisolithus tinctorius, (v) propagules of Piriformospora indica and propagules of Laccaria lacata, (vi) propagules of Laccaria lacata and propagules of Pisolithus tinctorius, (vii) propagules of Laccaria lacata and propagules of Laccaria bicolor, (viii) propagules of Piriformospora indica, propagules of Laccaria lacata, and propagules of Pisolithus tinctorius, (ix) propagules of Piriformospora indica, propagules of Laccaria bicolor and propagules of Laccaria lacata, (x) propagules of Laccaria bicolor, propagules of Laccaria lacata, and propagules of Pisolithus tinctorius and (xi) propagules of Piriformospora indica, propagules of Laccaria bicolor, propagules of Laccaria lacata, and propagules of Pisolithus tinctorius.

In an embodiment, the mycorrhizal propagules comprise a combination of endomycorrhiza and ectomycorrhiza.

In an embodiment, the composition of the present disclosure comprises agriculturally beneficial agents, wherein the agriculturally beneficial agent is mycorrhizal propagules selected from endomycorrhiza, ectomycorrhiza or a combination thereof; and an extract of a plant belonging to Dodonaea genus. The composition comprises mycorrhizal fungi as agriculturally beneficial agents comprising endomycorrhiza, ectomycorrhiza or a combination thereof in an amount ranging from about 0.1% to about 90% by weight of the composition, including the sub-ranges described above.

In an embodiment, the composition of the present disclosure comprises agriculturally beneficial agents, wherein the agriculturally beneficial agent is endomycorrhiza; and an extract of a plant belonging to Dodonaea genus. The composition comprises agriculturally beneficial agents comprising endomycorrhiza in an amount ranging from about 0.1% to about 90% by weight of the composition, including the sub-ranges described above. In an embodiment, the mycorrhizal propagules include propagules of endomycorrhiza selected from one or more of Rhizophagus irregularis, Rhizophagus clarus, Gigaspora margarita and Scutellospora heterogama. In an embodiment, the mycorrhizal propagules comprise a combination of propagules of endomycorrhiza. The combination of mycorrhizal propagules includes various combinations of Rhizophagus irregularis, Rhizophagus clarus, Gigaspora margarita and Scutellospora heterogama as described above.

In an embodiment, the composition of the present disclosure comprises agriculturally beneficial agents comprising a combination of endomycorrhiza and ectomycorrhiza in weight ratios ranging from 1:10 to 10:1. In an embodiment, the weight ratio of endomycorrhiza to ectomycorrhiza in the composition ranges from 1:9 to 9:1. In an embodiment, the weight ratio of endomycorrhiza to ectomycorrhiza in the composition ranges from 3:7 to 7:3. In an embodiment, the weight ratio of endomycorrhiza to ectomycorrhiza in the composition ranges from 2:3 to 3:2. In an embodiment, the weight ratio of endomycorrhiza to ectomycorrhiza in the composition ranges from 1:4 to 4:1.

In an embodiment, wherein the mycorrhizal propagules comprise a combination of endomycorrhiza and ectomycorrhiza, the propagules of endomycorrhiza are present in an amount ranging from about 10% to about 80% by weight of the mycorrhizal propagules.

In an embodiment, wherein the mycorrhizal propagules comprise a combination of endomycorrhiza and ectomycorrhiza, the propagules of ectomycorrhiza are present in an amount ranging from about 20% to about 90% by weight of the mycorrhizal propagules.

In an embodiment, mycorrhizal propagules comprise: (a) propagules of endomycorrhiza selected from Rhizophagus irregularis, Rhizophagus clarus, Gigaspora margarita, Scutellospora heterogama and combinations thereof in an amount ranging from about 10% to about 80% by weight of the mycorrhizal propagules; and (b) propagules of ectomycorrhiza selected from Piriformospora indica, Laccaria bicolor, Laccaria lacata, Pisolithus tinctorius and combinations thereof in an amount ranging from about 20% to about 90% by weight of the mycorrhizal propagules.

In an embodiment, mycorrhizal propagules comprise: (a) propagules of endomycorrhiza selected from Rhizophagus irregularis, Rhizophagus clarus, Gigaspora margarita, Scutellospora heterogama, and combinations thereof in an amount of about 70% by weight of the mycorrhizal propagules; and (b) propagules of ectomycorrhiza selected from Piriformospora indica, Laccaria bicolor, Laccaria lacata, Pisolithus tinctorius, and combinations thereof in an amount of about 30% by weight of the mycorrhizal propagules.

In an embodiment, mycorrhizal propagules comprise: (a) propagules of endomycorrhiza selected from Rhizophagus irregularis, Rhizophagus clarus, Gigaspora margarita, Scutellospora heterogama, and combinations thereof in an amount of about 30% by weight of the mycorrhizal propagules; and (b) propagules of ectomycorrhiza selected from Piriformospora indica, Laccaria bicolor, Laccaria, lacata, Pisolithus tinctorius, and combinations thereof in an amount of about 70% by weight of the mycorrhizal propagules.

In an embodiment, the number of propagules in the combinations or the compositions of the present disclosure range from about 1×10⁴ propagules/g to about 9×10⁶ propagules/g.

In an embodiment, the combinations or the compositions of the present disclosure comprise about 0.5×10⁵ to 2×10⁵ propagules/g. In an embodiment, the combinations or the compositions of the present disclosure comprise about 1×10⁵ propagules/g.

In an embodiment, the mycorrhizal propagules are in a size range of 60-150 microns, more preferably 70-80 microns. In a preferred embodiment, the mycorrhizal propagules are of 75 microns in size.

In an embodiment, the compositions of the present disclosure further comprise one or more bacterial endophytes. The endophytes are root endophytic bacteria and are selected from a group comprising Enterobacter, Pseudomonas, Stenotrophomonas, Azospirillum, Azorhizobium, Azovibrio, Polyangium, Ramlibacter, Rubrivivax, Sphingomonas, Rhizobium, Streptomyces, Amycolatopsis, Fraturia, Pseudonocardia, Sphingomonas, Massilia, Methylobacterium, Bradyrhizobium, Bosea, Bacillus, Paenibacillus, Azotobacter, Glucanoacetobacter, or combinations thereof. The bacterial endophytes are present in the composition wherein the compositions comprise mycorrhizal fungi as the agriculturally beneficial agent.

In an embodiment, the endophytic bacteria are selected from the group consisting of Pseudomonas fluorescens, Pseudomonas putida, Bacillus subtilis, Bacillus amyloliquefaciens, Bacillus aryabhattai, Rhizobium leguminosarum, Azorhizobium caulidans, Fraturia aurentia, Bacillus megaterium, Bacillus amyloliquefaciens, Azotobacter chrococcum, Azospirilum lipoferum, Glucanoacetobacter diazotrophicus, Streptomyces viridochromogenes, Streptomyces hygroscopicus, Paenibacillus polymyxa, Streptomyces koyangenesis, Streptomyces iarkyus, and combinations thereof.

In one embodiment, the endophytic bacteria are Pseudomonas aeruginosa or Pseudomonas fluorescens.

In one embodiment, the endophytic bacteria are Pseudomonas putida.

In one embodiment, the endophytic bacteria are Bacillus amyloliquefaciens.

In one embodiment, the endophytic bacteria are Paenibacillus polymyxa.

In another embodiment, the endophytic bacteria are Bacillus subtilis.

In yet another embodiment, the endophytic bacteria are a combination of Pseudomonas and Bacillus. In an embodiment, the endophytic bacteria are a combination of Pseudomonas aeruginosa and Bacillus subtilis. In another embodiment, the endophytic bacteria are a combination of Pseudomonas fluorescens and Bacillus subtilis.

In an embodiment, Bacillus subtilis is Bacillus subtilis deposited as MTCC 25520.

In an embodiment, Pseudomonas fluorescens is Pseudomonas fluorescens deposited as MTCC 25519.

In an embodiment, Bacillus amyloliquefaciens is Bacillus amyloliquefaciens deposited as MTCC 25518.

In an embodiment, Pseudomonas putida is Pseudomonas putida deposited as MTCC 25607.

In an embodiment, Paenibacillus polymyxa is Paenibacillus polymyxa deposited as MTCC 25609.

In an embodiment, the endophytic bacteria are present in an amount ranging from about 0.1% to about 20%, about 0.1% to about 10%, or about 0.5% to about 5% by weight of the total composition.

In an embodiment, the composition further comprises one or more agriculturally acceptable excipient. In an embodiment, the agriculturally acceptable excipients are selected from any or a combination of wetting agent, dispersing agent, binding agent, surfactant/emulsifier, anti-freezing agent, mineral, filler, stabilizer, and preservative. However, it should be appreciated that any other agriculturally acceptable excipients, as known to a person skilled in the art, may be used to serve its intended purpose without departing from the scope of the present disclosure. In an embodiment, the agriculturally acceptable excipients are present in an amount ranging from 0.3% to 99% by weight of the composition. In an embodiment, the stabilizer is selected from any or a combination of: humic acid, methyl cellulose, Xanthan gum, polyvinylpyrrolidone (PVP), Tween and Gum Arabica. In an embodiment, the amount of stabilizer in the composition of the present disclosure ranges from 0.2% to about 80% by weight of the composition.

Another embodiment of the present disclosure provides an agricultural composition, the composition comprising: mycorrhizal propagules and an extract of Dodonaea viscosa. In an embodiment, the mycorrhizal propagules comprise propagules of endomycorrhiza. In another embodiment, the mycorrhizal propagules comprise propagules of ectomycorrhiza. In an embodiment, the composition further comprises one or more of endophytic bacteria, a stabilizer and an agriculturally acceptable excipient.

An embodiment of the present disclosure provides an agricultural composition, the composition comprising: a combination of endomycorrhizal and ectomycorrhizal propagules and an extract of Dodonaea viscosa. In an embodiment, the composition further comprises one or more of endophytic bacteria, a stabilizer, and an agriculturally acceptable excipient.

Another embodiment of the present disclosure provides an agriculturally beneficial composition, the composition comprising: mycorrhizal propagules; an extract of Dodonaea viscosa; a stabilizer; and an agriculturally acceptable excipient. The stabilizer serves as a source of carbon aiding in improving survivability of mycorrhizal propagules and improving shelf life of the composition. In some embodiments, the extract of Dodonaea viscosa also exerts stabilizing effect on mycorrhizal propagules, aiding in improving shelf life of the composition.

In an embodiment, the composition comprises: (a) mycorrhizal propagules in an amount ranging from about 5% to about 40% by weight of the composition; (b) an extract of Dodonaea viscosa in an amount ranging from about 0.2% to about 20% by weight of the composition; (c) a stabilizer in an amount ranging from about 0.2% to about 80% by weight of the composition; and (d) an agriculturally acceptable excipient.

In an embodiment, the stabilizer is selected from a group comprising: humic acid, cellulose, methyl cellulose, Xanthan gum, polyvinylpyrrolidone (PVP), Tween (polysorbates), Gum Arabica, or combinations thereof. In an embodiment, the stabilizer comprises humic acid and methyl cellulose. In an embodiment, the stabilizer comprises humic acid and cellulose.

In an embodiment, the composition is formulated into a gel or a granule.

In an embodiment, the composition comprises: (a) mycorrhizal propagules in an amount ranging from about 5 to about 40% by weight of the composition; (b) an extract of Dodonaea viscosa in an amount ranging from about 0.2% to about 20% by weight of the composition; (c) humic acid in an amount ranging from about 1% to about 50% by weight of the composition; (d) cellulose or methyl cellulose in an amount ranging from about 0.1% to about 5% by weight of the composition; and (e) an agriculturally acceptable excipient in an amount sufficient to prepare said composition.

In some embodiments, the amount of humic acid in the composition ranges from about 5% to about 50%, about 5% to about 45%, about 5% to about 40%, about 5% to about 35%, about 5% to about 30%, about 5% to about 25%, about 5% to about 20%, about 10% to about 50%, about 10% to about 40%, about 10% to about 30%, about 20% to about 50%, about 20% to about 40%, or about 25% to about 50%, by weight of the composition

In some embodiments, the amount of cellulose or methyl cellulose in the composition ranges from about 0.1% to about 5%, about 0.1% to about 4.5%, about 0.1% to about 4%, about 0.1% to about 3.5%, about 0.1% to about 3%, about 0.1% to about 2.5%, about 0.1% to about 2%, about 0.1% to about 1.5%, about 0.1% to about 1%, by weight of the composition

In an embodiment, the mycorrhizal propagules are selected from propagules of endomycorrhiza, propagules of ectomycorrhiza and combinations thereof. In an embodiment, the mycorrhizal propagules comprise propagules of endomycorrhiza selected from Rhizophagus irregularis, Rhizophagus clarus, Gigaspora margarita, Scutellospora heterogama, and combinations thereof. In an embodiment, the mycorrhizal propagules comprise propagules of ectomycorrhiza selected from Piriformospora indica, Laccaria bicolor, Laccaria lacata, Pisolithus tinctorius, and combinations thereof.

In an embodiment, mycorrhizal propagules comprise: (a) propagules of endomycorrhiza selected from Rhizophagus irregularis, Rhizophagus clarus, Gigaspora margarita, Scutellospora heterogama, and combinations thereof in an amount ranging from about 10% to about 80% by weight of the mycorrhizal propagules; and (b) propagules of ectomycorrhiza selected from Piriformospora indica, Laccaria bicolor, Laccaria lacata, Pisolithus tinctorius, and combinations thereof in an amount ranging from about 20% to about 90% by weight of the mycorrhizal propagules.

In an embodiment, mycorrhizal propagules comprise: (a) propagules of endomycorrhiza selected from Rhizophagus irregularis, Rhizophagus clarus, Gigaspora margarita, Scutellospora heterogama, and combinations thereof in an amount of about 70% by weight of the mycorrhizal propagules; and (b) propagules of ectomycorrhiza selected from Piriformospora indica, Laccaria bicolor, Laccaria lacata, Pisolithus tinctorius, and combinations thereof in an amount of about 30% by weight of the mycorrhizal propagules.

In an embodiment, mycorrhizal propagules comprise: (a) propagules of endomycorrhiza selected from Rhizophagus irregularis, Rhizophagus clarus, Gigaspora margarita, Scutellospora heterogama, and combinations thereof in an amount of about 30% by weight of the mycorrhizal propagules; and (b) propagules of ectomycorrhiza selected from Piriformospora indica, Laccaria bicolor, Laccaria lacata, Pisolithus tinctorius, and combinations thereof in an amount of about 70% by weight of the mycorrhizal propagules.

In an embodiment, the agriculturally acceptable excipient is selected from a group comprising, but not limited to, a wetting agent, dispersing agent, binding agent, surfactant/emulsifier, anti-freezing agent, mineral, filler, preservative, and combinations thereof.

The wetting agent is selected from a group comprising, but not limited to, sulfosuccinates, naphthalene sulfonates, sulfated esters, phosphate esters, sulfated alcohol, alkyl benzene sulfonates, and combinations thereof.

The dispersing agent is selected from a group comprising, but not limited to, polycarboxylates, naphthalene sulfonate condensates, phenol sulfonic acid condensates, lignosulfonates, methyl oleyl taurates, polyvinyl alcohols, and combinations thereof.

The binding agent is selected from a group comprising, but not limited to, polyvinyl alcohols, phenyl naphthalene sulphonates, lignin derivatives, polyvinyl pyrrolidone, polyalkylpyrrolidone, carboxymethylcellulose, xanthan gum, polyethoxylated fatty acids, polyethoxylated fatty alcohols, ethylene oxide copolymer, propylene oxide copolymer, polyethylene glycols, polyethylene oxides, and combinations thereof.

The surfactant is selected from a group comprising ionic surfactants, non-ionic surfactants, and combinations thereof. Non-limiting examples of ionic surfactants include sulfonic acids, sulfuric acid esters, carboxylic acids, and salts thereof. Non-limiting examples of water soluble anionic surfactants include alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, toluene sulfonates, xylene sulfonates, cumene sulfonates, alkyl benzene sulfonates, alkyl diphenyloxide sulfonate, alpha-olefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, N-acyl taurates, N-acyl-N-alkyltaurates, and alkyl carboxylates.

Non-limiting examples of the non-ionic surfactants include glycerol ethers, glycol ethers, ethanolamides, sulfoanylamides, alcohols, amides, alcohol ethoxylates, glycerol esters, glycol esters, ethoxylates of glycerol ester and glycol esters, sugar-based alkyl polyglycosides, polyoxyethylenated fatty acids, alkanolamine condensates, alkanolamides, tertiary acetylenic glycols, polyoxyethylenated mercaptans, carboxylic acid esters, polyoxyethylenated polyoxyproylene glycols, sorbitan fatty esters, or combinations thereof. Also included are EO/PO block copolymers (EO is ethylene oxide, PO is propylene oxide), EO polymers and copolymers, polyamines, and polyvinylpynolidones, sorbitan fatty acid alcohol ethoxylates and sorbitan fatty acid ester ethoxylates.

The anti-freezing agents is selected from a group comprising, but not limited to, ethylene glycol, propylene glycol, urea, glycerin, anti-freeze proteins, and combinations thereof.

The minerals are selected from a group comprising, but not limited to, kaolin, silica, titanium (IV) oxide, rutile, anatase, aluminum oxides, aluminum hydroxides, iron oxide, iron sulfide, magnetite, pyrite, hematite, ferrite, gregite, calcium carbonate, calcite, aragonite, quartz, zircon, olivine, orthopyroxene, tourmaline, kyanite, albite, anorthite, clinopyroxene, orthoclase, gypsum, andalusite, talc, fluorite, apatite, orthoclase, topaz, corundum, diamond, tin, tin oxides, antimony, antimony oxides, beryllium, cobalt, copper, feldspar, gallium, indium, lead, lithium, manganese, mica, molybdenum, nickel, perlite, platinum group metals, phosphorus and phosphate rock, potash, rare earth elements, tantalum, tungsten, vanadium, zeolites, zinc and zinc oxide, indium tin oxide, and combinations thereof.

The fillers are selected from a group comprising, but not limited to, diatomaceous earth, kaolin, bentonite, precipitated silica, attapulgite, perlite, and combinations thereof.

In an embodiment, the present disclosure provides an agricultural composition comprising an agriculturally beneficial composition comprising an agriculturally beneficial agent and an extract of a plant belonging to Dodonaea genus, wherein the agriculturally beneficial agent is a biological agent selected from bacteria, mycorrhizal fungi, and a combination thereof.

In an embodiment, the present disclosure provides an agricultural composition comprising an agriculturally beneficial composition comprising an agriculturally beneficial agent and an extract of a plant belonging to Dodonaea genus, wherein the agriculturally beneficial agent is mycorrhizal fungi.

In an embodiment, the present disclosure provides an agricultural composition comprising an agriculturally beneficial composition comprising an agriculturally beneficial agent and an extract of a plant belonging to Dodonaea genus, wherein the agriculturally beneficial agent is mycorrhizal fungi selected from endomycorrhiza, ectomycorrhiza or a combination thereof. In an embodiment, the composition may further comprise endophytic bacteria.

In an embodiment, the present disclosure provides an agricultural composition comprising an agriculturally beneficial composition comprising an agriculturally beneficial agent and an extract of a plant belonging to Dodonaea genus, wherein the agriculturally beneficial agent is bacteria.

In an embodiment, the present disclosure provides an agricultural composition comprising an agriculturally beneficial composition comprising an agriculturally beneficial agent and an extract of a plant belonging to Dodonaea genus, wherein the agriculturally beneficial agent is mycorrhizal fungi and bacteria.

In an embodiment, the present disclosure provides an agricultural composition comprising an agriculturally beneficial composition comprising an agriculturally beneficial agent and an extract of a plant belonging to Dodonaea genus, wherein the agriculturally beneficial agent is endomycorrhiza or propagules thereof selected from Glomus genera, Entrophospora, Funneliformis, Rhizophagus, Septoglomus, Acaulospora, Archaeospora, Paraglomus, Gigaspora, Pacispora, Sclerocystis, Dentiscutata, Scutellospora, and combinations thereof; and/or ectomycorrhiza or propagules thereof selected from Laccaria, Pisolithus, Piriformospora, Scleroderma, Rhizopogon, and combinations thereof; and/or bacteria selected from Actinomyces, Streptomyces, Mycobacterium, Nocardia, Corynebacterium, Streptococcus, Staphylococcus, Mycoplasma, Ureoplasma, Veillonella, Bacillus, Clostridium, Lactobacillus, Listeria, Rickettsia, Burkholderia, Escherichia, Pseudomonas, Legionella, Vibrio, Enterobacter, Stenotrophomonas, Azospirillum, Azovibrio, Polyangium, Ramlibacter, Rubrivivax, Sphingomonas, Rhizobium, Amycolatopsis, Pseudonocardia, Sphingomonas, Massilia, Methylobacterium, Bradyrhizobium, Bosea, Paenibacillus, Borrelia, Treponema, Leptospira, Gluconacetobacter, Azotobacter and combinations thereof. The composition may further comprise a stabilizer and/or an agriculturally acceptable excipient.

In an embodiment, the combinations or the compositions of the present disclosure may further be mixed with other agrochemically active ingredients or composition(s) comprising other agrochemically active ingredients. The other agrochemically active ingredients may be selected from fertilizers, micronutrients, acaricides, algicides, antifeedants, avicides, bactericides, bird repellents, chemosterilants, fungicides, herbicide safeners, herbicides, insect attractants, insect repellents, insecticides, mammal repellents, mating disruptors, molluscicides, nematicides, plant activators, plant-growth regulators, rodenticides, synergists, virucides, derivatives thereof, biological control agents or mixtures thereof. The said mixtures may be premixed compositions or may be tank mixed at the time of application. In an embodiment, a treatment may comprise combinations or the compositions of the present disclosure and other agrochemically active ingredients or composition(s) comprising other agrochemically active ingredients.

In a preferred embodiment, the other agrochemically active ingredient is selected from the group consisting of insecticides, fungicides, biostimulants, and combinations thereof. In an embodiment, the insecticides, fungicides, biostimulants may be according to any of the embodiments described above. In another preferred embodiment, the other agrochemically active ingredient is selected from the group consisting of acephate, cypermethrin, copper sulphate, mancozeb, propineb, thiamethoxam, folcisteine, Foltron®, Wuxal®, imidacloprid, carbendazim, spinetoram, orthosilicic acid (OSA), and combinations thereof. In a yet another preferred embodiment, the other agrochemically active ingredient is selected from the group consisting of acephate+cypermethrin, copper sulphate+mancozeb, propineb, thiamethoxam, folcisteine, Foltron®, Wuxal®, imidacloprid, carbendazim+mancozeb, spinetoram, orthosilicic acid (OSA), and combinations thereof.

The advantageous agricultural composition of the present disclosure is formulated in any of formulations such as gel, aerosol, emulsifiable concentrate, wettable powder, soluble concentrate, soluble powder, suspension concentrate, spray concentrate, capsule suspension, water dispersible granule, granules, dusts, microgranule seed treatment formulation and the likes.

The agricultural benefit may be conferred by treating a seed, a plant, a plant part, a soil, or a combination thereof, with a composition or formulation of the present disclosure under conditions leading to association between the composition and the seed, plant, plant part, soil, or combinations thereof. Application of a formulation to a target is accomplished using any delivery method known in the art including, but not limited to dusting, fumigation, granule application, injection, misting, seed treatment, spraying, dipping, or coating.

In an embodiment, the present disclosure provides a method of preparing an extract of a plant belonging to Dodonaea genus. In particular, the extract is that of Dodonaea viscosa. In an embodiment, said extract is an aqueous extract obtained using a Solid-Liquid extraction process.

In an embodiment, the present disclosure provides a method of preparing an extract of a plant belonging to Dodonaea genus comprising:
E. grinding leaves, stems, roots and/or other parts of a plant belonging to Dodonaea genus into small particles, grains or a powder;
F. mixing the powder obtained in step A with a solvent and stirring to obtain a suspension;
G. adding a buffer salt mixture to the suspension obtained in step B;
H. centrifuging the suspension of step C and separating the supernatant to obtain the extract of a plant belonging to Dodonaea genus.

In an embodiment, the present disclosure provides a method of preparing an extract of Dodonaea viscosa comprising:
A. grinding leaves, stems, roots and/or other parts of Dodonaea viscosa into small particles, grains or a powder;
B. mixing the powder obtained in step A with a solvent and stirring to obtain a suspension;
C. adding a buffer salt mixture to the suspension obtained in step B;
D. centrifuging the suspension of step C and separating the supernatant to obtain the extract of Dodonaea viscosa.

In an embodiment, said solvent is water.

In an embodiment, said extract is an aqueous extract of Dodonaea viscosa.

According to an embodiment, the present disclosure provides a method of improving plant health comprising applying to a plant, a plant propagation material, a site or medium of plant growth, or a locus an agricultural composition comprising an agriculturally beneficial agent and an extract of a plant belonging to Dodonaea genus. In an embodiment, the extract belongs to Dodonaea viscosa plant. The agriculturally beneficial agents are described herein the embodiments of the present disclosure. In a preferred embodiment, the agriculturally beneficial agent is mycorrhizal fungi. In a preferred embodiment, the agriculturally beneficial agent is bacteria. In a preferred embodiment, the agriculturally beneficial agent is mycorrhizal fungi and bacteria.

According to an embodiment, the present disclosure provides a method of improving plant health comprising applying to a plant, a plant propagation material, a site or medium of plant growth, or a locus an agricultural composition comprising mycorrhizal propagules; and an extract of a plant belonging to Dodonaea genus. In an embodiment, the extract belongs to Dodonaea viscosa plant.

The present disclosure accords a surprising effect of dose reduction of fertilizer in compositions comprising Dodonaea viscosa without compromising the bioefficacy.

In an embodiment, the combinations or the compositions of the present disclosure may be applied to seeds or any plant propagation material for seed treatment.

In an embodiment, the present disclosure provides a method of treating a seed of a plant comprising applying the agricultural composition comprising an agriculturally beneficial agent (e.g., mycorrhizal propagules, bacteria, herbicides, etc.) and an extract of a plant belonging to Dodonaea genus to the seed. In a preferred embodiment, the method comprises applying an agricultural composition comprising mycorrhizal propagules and an extract of Dodonaea viscosa. In a preferred embodiment, the method comprises applying an agricultural composition comprising bacteria and an extract of Dodonaea viscosa. In a preferred embodiment, the method comprises applying an agricultural composition comprising mycorrhizal propagules, endophytic bacteria and an extract of Dodonaea viscosa.

The term “plant propagation material” is to be understood to denote all the generative parts of the plant such as seeds and vegetative plant material such as cuttings and tubers (e. g. potatoes), which can be used for the multiplication of the plant. This includes seeds, roots, fruits, tubers, bulbs, rhizomes, shoots, sprouts and other parts of plants. Seedlings and young plants, which are to be transplanted after germination or after emergence from soil, are also included.

In an embodiment, the combinations or the compositions of the present disclosure may be applied to crops or seeds. Examples of the crops on which the combinations and compositions of the present disclosure may be used include, but are not limited to, corn, rice, wheat, barley, rye, oat, sorghum, cotton, soybean, peanut, buckwheat, beet, rapeseed, sunflower, sugar cane, tobacco, etc.; solanaceous vegetables such as eggplant, tomato, pimento, pepper, potato, etc.; cucurbit vegetables such as cucumber, pumpkin, zucchini, water melon, melon, squash, etc.; cruciferous vegetables such as radish, white turnip, horseradish, kohlrabi, Chinese cabbage, cabbage, leaf mustard, broccoli, cauliflower, etc.; asteraceous vegetables such as burdock, crown daisy, artichoke, lettuce, etc; liliaceous vegetables such as green onion, onion, garlic, and asparagus; ammiaceous vegetables such as carrot, parsley, celery, parsnip, etc.; chenopodiaceous vegetables such as spinach, Swiss chard, etc.; lamiaceous vegetables such as Perilla frutescens, mint, basil, etc, strawberry, sweet potato, Dioscorea japonica, colocasia, etc.; flowers, foliage plants, turf grasses; pome fruits such apple, pear, quince, etc.; stone fleshy fruits such as peach, plum, nectarine, Prunus mume, cherry fruit, apricot, prune, etc.; citrus fruits such as orange, lemon, rime, grapefruit, etc.; nuts such as chestnuts, walnuts, hazelnuts, almond, pistachio, cashew nuts, macadamia nuts, etc.; berries such as blueberry, cranberry, blackberry, raspberry, etc.; grape, kaki fruit, olive, plum, banana, coffee, date palm, coconuts, etc.; trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, and the like.

In an embodiment, the crops on which the combinations and compositions of the present disclosure may be used include paddy, wheat, barley, maize, millet, fiber crops, vegetable crops, fruit crops, spices, flowers, fodder, and plantations.

The combinations and the compositions of the present disclosure can be applied to a locus by the use of conventional ground sprayers, granule applicators, watering (drenching), drip irrigation, spraying, atomizing, broadcasting, dusting, foaming, spreading-on, aerial methods of spraying, aerial methods of application, methods utilizing application using modern technologies such as, but not limited to, drones, robots, and by other conventional means known to those skilled in the art.

In an embodiment, the combinations or the compositions of the present disclosure may be mixed or applied in conjunction with other agrochemically active ingredients or composition(s) comprising other agrochemically active ingredients. The other agrochemically active ingredients may be selected from fertilizers, micronutrients, acaricides, algicides, antifeedants, avicides, bactericides, bird repellents, chemosterilants, fungicides, herbicide safeners, herbicides, insect attractants, insect repellents, insecticides, mammal repellents, mating disruptors, molluscicides, nematicides, plant activators, plant-growth regulators, rodenticides, synergists, virucides, derivatives thereof, biological control agents or mixtures thereof. The said mixtures may be premixed compositions or may be tank mixed at the time of application. The combinations or the compositions of the present disclosure may be applied with the other agrochemically active ingredients jointly or separately in a sequential manner.

In an embodiment, the other agrochemically active ingredient is selected from the group consisting of insecticides, fungicides, biostimulants, and combinations thereof.

In an embodiment, the other agrochemically active ingredient is selected from the group consisting of acephate, cypermethrin, copper sulphate, mancozeb, propineb, thiamethoxam, folcisteine, Foltron®, Wuxal®, imidacloprid, carbendazim, spinetoram, orthosilicic acid (OSA), and combinations thereof.

In an embodiment, the other agrochemically active ingredient is selected from the group consisting of acephate+cypermethrin, copper sulphate+mancozeb, propineb, thiamethoxam, folcisteine, Foltron®, Wuxal®, imidacloprid, carbendazim+mancozeb, spinetoram, orthosilicic acid (OSA), and combinations thereof.

The biofertilizer compositions and/or formulations in accordance with the technology contained in the present invention is a multipurpose and multi-faceted product-it is a soil conditioner, bio-remediator, and bio-control agent and has wide applications in agriculture, plantations, horticulture, forestry. It offers sustainable and environment-friendly solutions to almost all cultivated plants and crops by enhancing nutrition and yields up to 5%- 60%, and curtailing fertilizer inputs by 50%.

While the foregoing description discloses various embodiments of the disclosure, other and further embodiments of the invention may be devised without departing from the basic scope of the disclosure. The invention is not limited to the described embodiments, versions, or examples, which are included to enable a person having ordinary skill in the art to make and use the invention when combined with information and knowledge available to the person having ordinary skill in the art.

### EXAMPLES

### Example A: Preparation of Dodonaea viscosa Extract

Aqueous extract of Dodonaea viscosa was prepared using Solid-Liquid extraction technique. Dodonaea viscosa was dried and ground into a powder. Said powder was added to a stirred reactor and mixed with equal volume of water. The temperature was kept constant (50-80° C.) and stirred continuously for 4-5 hours. A buffer salt mixture containing magnesium sulphate/calcium sulphate/potassium sulphate/sodium sulphate/sodium bisulphate and disodium acetate/sodium acetate/potassium acetate/calcium acetate was added to the suspension derived from stirrer. The suspension was then subjected to centrifugation for 15 min at 3000 rpm. The supernatant was separated and used as aqueous extract of Dodonaea viscosa.

### Examples 1-6: Endomycorrhiza and ectomycorrhiza Based Agricultural Formulations

Following examples 1-6 in Table 1 below depict gel or granule compositions comprising endomycorrhiza, ectomycorrhiza or a combination thereof, in conjunction with Dodonaea viscosa extract and further ingredients.

The endomycorrhiza used in the examples provided below are a combination of Rhizophagus irregularis, Rhizophagus clarus, Scutellospora heterogama and Gigaspora margarita. The endomycorrhiza are endomycorrhiza propagules.

The ectomycorrhiza used in the examples provided below are a combination of Piriformospora indica, Laccaria bicolor, and Pisolithus tinctorius. The ectomycorrhiza are ectomycorrhiza propagules.

TABLE 1
Details of mycorrhiza based agricultural compositions

| Example 1 | Example 2 | Example 3 | Example 4 | Example 5 | Example 6 |
|---|---|---|---|---|---|
| Gel | Gel | Gel | Granule | Gel | Gel |
| Dodonaea | Dodonaea | Dodonaea | Dodonaea | Dodonaea | Dodonaea |
| viscosa | viscosa | viscosa | viscosa | viscosa | viscosa |
| extract -1% | extract- 1% | extract- 1% | extract - | extract- 1% | extract - 1% |
| | | | 0.5% to 1% | | |
| Xanthan gum - | Humic acid - | Humic acid - | Humic acid - | Humic acid - | Humic acid - |
| 1% | 25% | 25% | 3.5% to 5.25% | 25% | 25% |
| Endomy- | Methyl | Cellulose - | Endophytes - | Methyl | Methyl |
| corrhiza - 20% | Cellulose - | 0.5% | 1.5% to 3% | Cellulose or | Cellulose or |
| | 0.5% | | | Cellulose - | Cellulose - |
| | | | | 0.5% | 0.5% |
| Inerts - 78% | Endomy- | Endomy- | Endomy- | Endomycor- | Endomycor- |
| | corrhiza | corrhiza | corrhiza | rhiza:Ectomy- | rhiza:Ectomy- |
| | propagules - | propagules - | propagules - | corrhiza | corrhiza |
| | 20% | 20% | 3% to 5% | propagules | propagules |
| | | | | (70:30) - 20% | (30:70) - 20% |
| | Inerts - 53.5% | Inerts - 53.5% | Ectomy- | Inerts - 53.5% | Inerts - 53.5% |
| | | | corrhiza | | |
| | | | propagules | | |
| | | | 0% to 2% | | |
| | | | Amino acid | | |
| | | | 0% to 2.5% | | |
| | | | Bentonite | | |
| | | | granules - | | |
| | | | 85% to 86% | | |
| | | | Inerts - 4.25% | | |

### Example 7: Stability of Mycorrhizal Compositions with and without Dodonaea viscosa

Following gel-based compositions were tested for their shelf-life and survivability of mycorrhiza.

TABLE 2
Details of mycorrhiza based agricultural compositions

| Composition 1 | Composition 2 | Composition 3 |
|---|---|---|
| Methyl cellulose -1% | Xanthan gum-1% | Humic acid- 50% |
| Cellulose - 1% | PVP - 0.5% | Cellulose - 3% |
| Endomycorrhiza - 20% | Endomycorrhiza - 20% | Endomycorrhiza - 20% |
| Inerts - 78% | Inerts - 78.5% | Inerts - 27% |
| Composition 4 | | |
| (Example 1) | Composition 5 | Composition 6 |
| Dodonaea viscosa | Xanthan gum-1% | Humic acid- 50% |
| extract -1% | | |
| Xanthan gum - 1% | Cellulose - 0.5% | Gum Arabica - 3% |
| Endomycorrhiza - 20% | Endomycorrhiza - 20% | Endomycorrhiza - 20% |
| Inerts - 78% | Inerts - 78.5% | Inerts - 27% |
| Composition 7 | | |
| (Example 3) | Composition 8 | Composition 9 |
| Humic acid - 25% | Gum Arabica -0.5% | Humic acid liquid - 75% |
| Cellulose - 0.5% | PVP - 0.5% | Cellulose - 3% |
| Dodonaea viscosa | Cellulose - 0.5% | Xanthan gum - 2% |
| extract -1% | | |
| Endomycorrhiza - 20% | Endomycorrhiza - 20% | Endomycorrhiza - 20% |
| Inerts - 53.5% | Inerts - 78.5% | |

The shelf-life and survivability parameters were tested using accelerated shelf-life studies. In an accelerated shelf-life study, increase in temperature than optimum is used to simulate real life aging and change in shelf-life. In this study, accelerated conditions (i.e., elevated temperature or humidity) are applied to the products to predict shelf-life over extended periods of time (up to 1 year). This means of testing is advantageous as results are obtained in a significantly shorter period reducing the longer wait-times for results compared to the actual shelf life assessment of the product. Accelerated testing may optionally be carried out in conjunction with standard shelf life testing for 100% accuracy.

The above compositions of Table 2 were packed in sterile HDPE bottles and stored at ambient temperature (25° C.) and accelerated temperature (50° C.) in triplicates for a period of 1 year. Samples in triplicate were drawn at regular intervals for analysis. The physical parameters like appearance, solubility in water, pH and density were recorded. The observations in physical parameters are recorded in the Table 3 below.

TABLE 3
Physical parameters of the compositions at 25° C. and 50° C.

| Composition | Physical appearance at 25° C. | Physical appearance at 50° C. |
|---|---|---|
| Composition 1 | Started becoming thick paste after | Started becoming thick paste |
| | 30 days of incubation | after 15 days of incubation |
| Composition 2 | Crystallization observed after 25 | Crystallization observed after |
| | days of incubation | 10 days of incubation |
| Composition 3 | Dried up as flakes after 45 days of | Dried up as flakes after 15 days |
| | incubation | of incubation |
| Composition 4 | Started becoming thick paste | Started becoming thick paste |
| (Example 1) | after 75 days of incubation | after 60 days of incubation |
| Composition 5 | Crystallization observed after 35 | Crystallization observed after |
| | days of incubation | 20 days of incubation |
| Composition 6 | Observed lump formation after 30 | Observed lump formation after |
| | days of incubation | 10 days of incubation |
| Composition 7 | No change in physical | No change in physical |
| (Example 3) | appearance. Stable gel | appearance. Stable gel |
| Composition 8 | Observed lump formation after 40 | Observed lump formation after |
| | days of incubation | 15 days of incubation |
| Composition 9 | Crystallization observed after 25 | Crystallization observed after |
| | days of incubation | 15 days of incubation |

Characteristics of composition of Example 3 are shown in Table 4 below.

TABLE 4
Characteristics of Composition 4 (Example
1) and Composition 7 (Example 3)

| Sr. No. | Physical Characteristics | Specification |
|---|---|---|
| 1. | Physical nature | Gel |
| 2. | Color | Dark brown |
| 3. | pH | 6.0-7.0 |

Viability studies were conducted by harvesting the spores from the compositions by wet sieving and decanting method and then stained with MTT (2,5-diphenyl-2N-tetrazolium bromide). The spores stained red, or pink were counted as viable spores.

$$\% Spore viability = \frac{No . of spores which stained red or pink \times 100}{Total number of spores}$$

TABLE 5
Viability of mycorrhiza in compositions for a period of 120 days

| | Mycorrhiza viability % | | | | | | | | | % Loss |
|---|---|---|---|---|---|---|---|---|---|---|
| | 0 | 15^{th} | 30^{th} | 45^{th} | 60^{th} | 75^{th} | 90^{th} | 105^{th} | 120^{th} | in 120 |
| Formulations | day | day | day | day | day | day | day | day | day | days |
| Composition | 95 | 95 | 95 | 90 | 85 | 70 | 65 | 52 | 45 | 52.63 |
| 1 - 25° C. | | | | | | | | | | |
| Composition | 97 | 97 | 97 | 80 | 75 | 60 | 55 | 42 | 40 | 58.76 |
| 1 - 50° C. | | | | | | | | | | |
| Composition | 98 | 98 | 97 | 90 | 83 | 78 | 75 | 62 | 55 | 43.88 |
| 2 - 25° C. | | | | | | | | | | |
| Composition | 95 | 95 | 90 | 78 | 75 | 60 | 55 | 52 | 35 | 63.16 |
| 2 - 50° C. | | | | | | | | | | |
| Composition | 97 | 97 | 95 | 80 | 75 | 55 | 50 | 42 | 35 | 63.92 |
| 3 - 25° C. | | | | | | | | | | |
| Composition | 95 | 93 | 93 | 92 | 89 | 76 | 70 | 62 | 55 | 42.11 |
| 3 - 50° C. | | | | | | | | | | |
| Composition | 95 | 95 | 95 | 92 | 85 | 80 | 75 | 72 | 65 | 31.58 |
| 4 (Example | | | | | | | | | | |
| 1) - 25° C. | | | | | | | | | | |
| Composition | 96 | 95 | 94 | 90 | 85 | 75 | 70 | 68 | 60 | 37.50 |
| 4 (Example | | | | | | | | | | |
| 1) - 50° C. | | | | | | | | | | |
| Composition | 95 | 95 | 85 | 80 | 75 | 60 | 55 | 50 | 45 | 52.63 |
| 5 - 25° C. | | | | | | | | | | |
| Composition | 95 | 90 | 75 | 70 | 65 | 60 | 45 | 42 | 35 | 63.16 |
| 5 - 50° C. | | | | | | | | | | |
| Composition | 96 | 95 | 90 | 80 | 65 | 50 | 45 | 35 | 30 | 68.75 |
| 6 - 25° C. | | | | | | | | | | |
| Composition | 95 | 85 | 65 | 60 | 45 | 40 | 38 | 32 | 25 | 73.68 |
| 6 - 50° C. | | | | | | | | | | |
| Composition | 95 | 95 | 95 | 95 | 95 | 94 | 93.5 | 93 | 93 | 2.11 |
| 7 (Example | | | | | | | | | | |
| 3) - 25° C. | | | | | | | | | | |
| Composition | 97 | 97 | 97 | 95 | 95 | 94 | 92 | 92 | 90 | 7.22 |
| 7 (Example | | | | | | | | | | |
| 3) - 50° C. | | | | | | | | | | |
| Composition | 95 | 95 | 95 | 90 | 85 | 70 | 65 | 52 | 45 | 52.63 |
| 8 - 25° C. | | | | | | | | | | |
| Composition | 95 | 95 | 95 | 90 | 85 | 70 | 65 | 52 | 45 | 52.63 |
| 8 - 50° C. | | | | | | | | | | |
| Composition | 98 | 98 | 90 | 72 | 65 | 55 | 47 | 40 | 38 | 61.22 |
| 9 - 25° C. | | | | | | | | | | |
| Composition | 96 | 96 | 87 | 70 | 60 | 50 | 40 | 35 | 30 | 68.75 |
| 9 - 50° C. | | | | | | | | | | |

Based on the observations in Tables 2 and 4, it could be concluded that compositions comprising Dodonaea viscosa extract had a better viability compared to other formulations. Compared to other compositions, Composition 4 (Example 1) and 7 (Example 3) were found to have better shelf life and spore viability after 120 days at ambient as well as high temperatures.

### Example 8: Efficacy of Mycorrhizal Composition with Dodonaea viscosa

Composition of Example 3 was checked for its activity and was evaluated against seedlings of various crops such as Tomato, Chilli and Brinjal, results whereof are provided in Table 5 below. The control used in the experiment was devoid of Dodonaea viscosa extract.

TABLE 5
Growth parameters of the seedlings treated
with Composition of Example 3

| | Root length (cm) | | | Shoot length (cm) | | |
|---|---|---|---|---|---|---|
| Formulations | Tomato | Chilli | Brinjal | Tomato | Chilli | Brinjal |
| Composition of | 38.45 | 34.35 | 28.45 | 78.35 | 60.16 | 75.34 |
| example 3 | | | | | | |
| Control | 20.35 | 19.54 | 17.56 | 60.02 | 50.21 | 59.32 |

As can be seen from Table 5 above, the composition of Example 3 resulted in better plant vigor and growth as compared to the control, thus confirming efficacious nature of the composition.

### Example 9: Efficacy of Mycorrhizal Composition with Dodonaea viscosa

Compositions including proportions of ectomycorrhiza and endomycorrhiza were prepared, composition details whereof are provided in Table 6 below.

TABLE 6
Formulations including a combination
of ectomycorrhiza and endomycorrhiza

| Composition 1 | Composition 2 (Example 5) |
|---|---|
| Humic acid - 50% | Humic acid - 25% |
| Methyl Cellulose - 0.5% | Methyl Cellulose - 0.5% |
| Tween - 1% | Dodonaea viscosa extract- 1% |
| Endomycorrhiza:Ectomycor- | Endomycorrhiza:Ectomycor- |
| rhiza (70:30) - 20% | rhiza (70:30) - 20% |
| Excipients - 23.5% | Excipients - 53.5% |

These compositions were applied to Tomato and Brinjal seedlings and growth parameters were recorded after 3 months of sowing. A control devoid of Dodonaea viscosa extract and mycorrhiza was used for comparison of efficacy of the compositions. Composition 2 (Example 5) gave best results with regard to growth parameters, wherein seedlings treated with Composition 2 (Example 5) showed increased colonization, higher root length and higher shoot length as compared to the other composition. Details of the growth parameters corresponding to seedling treated with Composition 2 (Example 5) and control are provided in Table 7 and 8 below.

TABLE 7
Growth parameters of the seedlings

| | Root length (cm) | | Shoot length (cm) | |
|---|---|---|---|---|
| Composition | Tomato | Brinjal | Tomato | Brinjal |
| Control | 27.32 | 19.56 | 58.14 | 59.04 |
| Composition 1 | 32.08 | 24.04 | 59.99 | 60.96 |
| Composition 2 (Example 5) | 35.45 | 27.34 | 65.78 | 67.89 |

TABLE 8
Endomycorrhizal root colonization

| | endomycorrhizal root colonization (%) | |
|---|---|---|
| Composition | Tomato | Brinjal |
| Composition 1 | 80 | 80 |
| Composition 2 (Example 5) | 92 | 95 |

Based on the experiments and bio-efficacy trials, it could be concluded that compositions with Dodonaea viscosa extract performed better in improving the plant growth and helping the root colonization by the mycorrhiza. Based on experimental results, it is evidently clear that these components in unison affords an increased colonization, and thereby increased plant vigor and growth in various crops. Moreover, it is noteworthy that the Composition 2 (Example 5) demonstrates significant efficacy with reduced dose of humic acid, which is 50% less as compared to the Composition 1. Thus, the compositions of the present invention provide a cost benefit along with reduced use of ingredients to achieve equal or more efficacy.

### Example 10: Efficacy of Mycorrhizal Composition with Dodonaea viscosa

Compositions including proportions of ectomycorrhiza and endomycorrhiza were prepared, composition details whereof are provided in Table 8 below.

TABLE 8
Formulations including a combination of
ectomycorrhiza and endomycorrhiza
Composition of Example 6

Humic acid - 25%
Dodonaea viscosa extract - 1%
Cellulose - 0.5%
Endomycorrhiza:Ectomycorrhiza (30:70) - 20%
Inerts - 53.5%

The composition of example 6 when applied to Moringa oleifera (Drumstick) and Psidium guajava (Guava) seedlings resulted in increased plant vigor and growth. Growth parameters were recorded after 3 months of sowing. A control devoid of Dodonaea viscosa extract was used for comparison.

TABLE 9
Growth parameters of the seedlings treated
with composition of Example 6:

| | Root length (cm) | | Shoot length (cm) | |
|---|---|---|---|---|
| Combination | Moringa | Psidium | Moringa | Psidium |
| Composition of Example 6 | 29.95 | 33.85 | 65.57 | 75.45 |
| Control | 18.05 | 20.15 | 49.98 | 64.32 |

### Example 11: Compatibility of Composition of Example 3 with Other Agrochemically Active Ingredients

A standard test procedure was followed to test compatibility of the pesticides mentioned in below table with the composition of Example 3. The chemical pesticides were used for tank mix to check the compatibility with the composition of Example 3. Tap water having pH of 7.26 and temperature 30° C. was used as a carrier for mixing.

TABLE 10
Active ingredients used for tank-mix compatibility
with the composition of example 3

| Active ingredient | Dosage (g or ml/ac) |
|---|---|
| Wuxal ® | 500 |
| Ortho silicic acid | 500 |
| Spinetoram | 180 |
| Imidacloprid | 100 |
| Carbendazim 12% + Mancozeb 63% WP | 500 |
| Imidacloprid | 50 |
| Foltron ® | 1000 |
| Thiamethoxam 25% WG | 100 |
| Propineb 70% WP | 500 |
| Copper Sulphate + Mancozeb | 2000 |
| Acephate 45% + Cypermethrin 5% | 500 g |

TABLE 11
Active ingredients used for tank-mix compatibility
with the composition of Example 3

Treatment:

| Combination of | Percent Viability of Propagules | | | | | |
|---|---|---|---|---|---|---|
| composition of | 0 | 2 | 4 | 6 | 20 | 24 |
| Example 3 with: | hour | hours | hours | hours | hours | hours |
| Orthosilicic acid | 97 | 95 | 92 | 90 | 90 | 90 |
| Spinetoram | 97 | 95 | 92 | 85 | 85 | 70 |
| Imidacloprid | 97 | 95 | 95 | 80 | 75 | 70 |
| (100 g/acre) | | | | | | |
| Carbendazim + | 97 | 97 | 95 | 95 | 92 | 90 |
| mancozeb | | | | | | |
| Imidocloprid | 95 | 95 | 92 | 90 | 85 | 80 |
| (50 g/acre) | | | | | | |
| Wuxal ® | 97 | 95 | 90 | 85 | 80 | 75 |
| Foltron ® | 97 | 97 | 95 | 85 | 80 | 80 |
| Thiamethoxam | 95 | 95 | 95 | 95 | 93 | 93 |
| Propineb | 95 | 95 | 95 | 95 | 92 | 92 |
| Copper sulphate + | 98 | 98 | 95 | 95 | 95 | 95 |
| mancozeb | | | | | | |
| Acephate + | 95 | 95 | 95 | 95 | 95 | 95 |
| cypermethrin | | | | | | |

It is evident from Table 12 that the compositions are compatible with other agrochemically active ingredients and show a good level of spore viability suggesting that such combinations can be used together.

### Example 12: Granular Compositions of Mycorrhiza and Dodonaea viscosa Extract

The following table demonstrates granular compositions comprising mycorrhizal propagules and Dodonaea viscosa extract along with other additives. A mother liquor comprising mycorrhizal propagules, Dodonaea viscosa extract, endophytes and other additives was prepared and sprayed or coated on bentonite granules to obtain granular compositions of mycorrhizal propagules and Dodonaea viscosa extract. The mycorrhizal propagules used was a consortium of Rhizophagus irregularis, Rhizophagus clarus, Gigaspora margarita, Scutellospora heterogama, and Ectomycorrhiza—Pisolithus tinctorius and Piriformospora indica. The endophytes used were selected from Bacillus amyloliquefaciens, Pseudomonas fluorescens, Bacillus subtilis, Pseudomonas putida, Paenibacillus or combinations thereof.

The following Table 12 demonstrates the various granular compositions.

TABLE 12
Granular compositions of mycorrhiza and Dodonaea viscosa extract

| Composition 1 | Composition 2 | Composition 3 |
|---|---|---|
| Bentonite granules - 86% | Bentonite granules - 86% | Bentonite granules - 86% |
| Dodonaea viscosa extract - 1.0% | Dodonaea viscosa extract - 1.0% | Dodonaea viscosa extract - 1.0% |
| Amino acid - 2.5% | Amino acid - 2.5% | Amino acid - 2.5% |
| Humic acid - 3.5% | Humic acid - 3.5% | Humic acid - 3.5% |
| Endomycorrhiza - 4.0% | Endomycorrhiza - 4.0% | Endomycorrhiza - 4.0% |
| Ectomycorrhiza - 1.5% | Ectomycorrhiza - 1.5% | Ectomycorrhiza - 1.5% |
| Bacillus amyloliquefaciens - 0.75%. | Pseudomonas fluorescens - 1.5% | Pseudomonas fluorescens - 0.75% |
| Bacillus subtilis - 0.75% | | Bacillus amyloliquefaciens - 0.75% |

| Composition 4 | Composition 5 | Composition 6 |
|---|---|---|
| Bentonite granules - 86% | Bentonite granules - 86% | Bentonite granules - 86% |
| Dodonaea viscosa extract - 1.0% | Dodonaea viscosa extract - 1.0% | Dodonaea viscosa extract - 1.0% |
| Amino acid - 2.5% | Amino acid - 2.5% | Amino acid - 2.5% |
| Humic acid - 3.5% | Humic acid - 3.5% | Humic acid - 3.5% |
| Endomycorrhiza - 4.0% | Endomycorrhiza - 4.0% | Endomycorrhiza - 4.0% |
| Ectomycorrhiza - 1.5% | Ectomycorrhiza - 1.5% | Ectomycorrhiza - 1.5% |
| Pseudomonas fluorescens - 0.75% | Pseudomonas putida - 0.75% | Pseudomonas putida - 0.75% |
| Pseudomonas putida - 0.75% | Bacillus amyloliquifaciens - 0.75% | Peanibacillus sp. - 0.75% |
| Composition 7 | Composition 8 | Composition 9 |
| Bentonite granules - 86% | Bentonite granules - 86% | Bentonite granules - 86% |
| Dodonaea viscosa extract - 1.0% | Dodonaea viscosa extract - 1.0% | Dodonaea viscosa extract - 1.0% |
| Amino acid - 2.5% | Amino acid - 2.5% | Amino acid - 2.5% |
| Humic acid - 3.5% | Humic acid - 3.5% | Humic acid - 3.5% |
| Endomycorrhiza - 4.0% | Endomycorrhiza - 4.0% | Endomycorrhiza - 4.0% |
| Ectomycorrhiza - 1.5% | Ectomycorrhiza - 1.5% | Ectomycorrhiza - 1.5% |
| Pseudomonas fluorescens - 0.75% | Paenibacillus sp. - 0.75% | Paenibacillus sp. - 1.5% |
| Bacillus subtilis - 0.75% | Bacillus amyloliquifaciens - 0.75% | |

Composition 10
Dodonaea viscosa extract - 0.5%
Humic acid - 5.25%
Endophytes - 2%
Mycorrhiza propagules - 3%
Bentonite granules - 85%
Inerts - 4.25%

Compositions 1-10 were tested for efficacy on plant growth (shoot growth and root growth) in tomato, chilli and brinjal. A control devoid of Dodoanea viscosa extract was used for comparison. The observations are recorded in the below Table 13.

TABLE 13
Efficacy of granular compositions of mycorrhizal
propagules and Dodonaea viscosa.

| | Root length (cm) | | | Shoot length (cm) | | |
|---|---|---|---|---|---|---|
| Formulations | Tomato | Chilli | Brinjal | Tomato | Chilli | Brinjal |
| Composition 1 | 34.29 | 32.57 | 26.98 | 77.67 | 60.32 | 77.34 |
| Composition 2 | 33.76 | 31.95 | 25.01 | 77.15 | 59.95 | 75.15 |
| Composition 3 | 33.29 | 31.67 | 25.16 | 75.55 | 60.59 | 74.25 |
| Composition 4 | 35.35 | 33.32 | 29.34 | 79.00 | 60.52 | 75.32 |
| Composition 5 | 36.52 | 33.95 | 27.98 | 76.28 | 62.15 | 73.26 |
| Composition 6 | 34.83 | 32.10 | 25.33 | 75.95 | 61.56 | 76.95 |
| Composition 7 | 38.56 | 34.68 | 31.23 | 80.98 | 63.99 | 80.16 |
| Composition 8 | 35.26 | 31.56 | 27.44 | 78.55 | 60.32 | 75.98 |
| Composition 9 | 34.75 | 32.37 | 24.98 | 77.95 | 60.95 | 77.95 |
| Composition 10 | 33.09 | 31.17 | 24.32 | 75.45 | 60.05 | 73.15 |
| Control | 21.54 | 20.32 | 18.99 | 63.95 | 54.87 | 60.12 |

From the above table 13, it is evident that compositions comprising Dodonaea viscosa extract (Compositions 1-10) showed better efficacy in promoting growth in the plants.

### Example 13: Viability of Gluconacetobacter diazotrophicus with Dodonaea viscosa Extract

Gluconacetobacter diazotrophicus was formulated with 1% Dodonaea viscosa extract and 5% Dodonaea viscosa extract and packed properly in sterile HDPE bottles and stored at ambient temperature (25° C.) and accelerated temperature (40° C.) in triplicates. Samples in triplicate are drawn at regular intervals for analysis. The viability of the strain in different temperatures are studied by serial dilution plating at 10⁷, 10⁸ and 10⁹ dilutions on agar media.

TABLE 14
Survivability of Gluconacetobacter diazotrophicus with different concentrations of Dodonaea viscosa extract

| | 0 day | | 1^{st} week | | 2^{nd} week | | 3^{rd} week | | 4^{th} week | |
|---|---|---|---|---|---|---|---|---|---|---|
| Composition | 25° C. | 40° C. | 25° C. | 40° C. | 25° C. | 40° C. | 25° C. | 40° C. | 25° C. | 40° C. |
| 1.0% DV + | 10 × 10⁹ | 9 × 10⁹ | 10 × 10⁹ | 9 × 10⁹ | 10 × 10⁹ | 10 × 10⁹ | 9 × 10⁹ | 9 × 10⁹ | 11 × 10⁹ | 9 × 10⁹ |
| G. diazotrophicus | | | | | | | | | | |
| 5.0% DV + | 9 × 10⁹ | 9 × 10⁹ | 11 × 10⁹ | 9 × 10⁹ | 10 × 10⁹ | 9 × 10⁹ | 10 × 10⁹ | 8 × 10⁹ | 10 × 10⁹ | 10 × 10⁹ |
| G. diazotrophicus | | | | | | | | | | |
| G. diazotrophicus | 10 × 10⁹ | 11 × 10⁹ | 11 × 10⁹ | 10 × 10⁹ | 9 × 10⁹ | 9 × 10⁹ | 8 × 10⁹ | 10 × 10⁹ | 10 × 10⁹ | 9 × 10⁹ |
| (without DV) | | | | | | | | | | |

DV—Dodonaea viscosa extract

From the table, it is evident that Gluconacetobacter diazotrophicus has stable viability upto 4 weeks when formulated with 1% and 5% D. viscosa extracts.

### Example 14: Viability of Azotobacter chroococcum with Dodonaea viscosa Extract

Azotobacter chroococcum was formulated with 1% Dodonaea viscosa extract and 5% Dodonaea viscosa extract and packed properly in sterile HDPE bottles and stored at ambient temperature (25° C.) and accelerated temperature (40° C.) in triplicates. Samples in triplicate are drawn at regular intervals for analysis. The viability of the strain in different temperatures are studied by serial dilution plating at 10⁷, 10⁸ and 10⁹ dilutions on agar media.

TABLE 15
Survivability of Azotobacter chroococcum with different concentrations of Dodonaea viscosa extract

| | 0 day | | 1^{st} week | | 2^{nd} week | | 3^{rd} week | |
|---|---|---|---|---|---|---|---|---|
| Composition | 25° C. | 40° C. | 25° C. | 40° C. | 25 C | 40° C. | 25° C. | 40° C. |
| 1.0% DV + | 10 × 10⁹ | 10 × 10⁹ | 9 × 10⁹ | 10 × 10⁹ | 10 × 10⁹ | 9 × 10⁹ | 10 × 10⁹ | 10 × 10⁹ |
| Azotobacter chroococcum | | | | | | | | |
| 5.0% DV + | 9 × 10⁹ | 11 × 10⁹ | 10 × 10⁹ | 10 × 10⁹ | 9 × 10⁹ | 10 × 10⁹ | 10 × 10⁹ | 9 × 10⁹ |
| Azotobacter chroococcum | | | | | | | | |
| Azotobacter chroococcum | 10 × 10⁹ | 11 × 10⁹ | 12 × 10⁹ | 10 × 10⁹ | 10 × 10⁹ | 8 × 10⁹ | 9 × 10⁹ | 8 × 10⁹ |
| (without DV) | | | | | | | | |

DV—Dodonaea viscosa extract

From the table, it is evident that Azotobacter chroococcum has stable viability upto 3 weeks when formulated with 1% and 5% D. viscosa extracts.

### Example 15: Viability of Rhizobium leguminosarum with Dodonaea viscosa Extract

Rhizobium leguminosarum was formulated with 2% Dodonaea viscosa extract and 3% Dodonaea viscosa extract and packed properly in sterile HDPE bottles and stored at ambient temperature (25° C.) and accelerated temperature (40° C.) in triplicates. Samples in triplicate are drawn at regular intervals for analysis. The viability of the strain in different temperatures are studied by serial dilution plating at 10⁷, 10⁸ and 10⁹ dilutions on agar media.

TABLE 16
Survivability of Rhizobium leguminosarum with different
concentrations of Dodonaea viscosa extract

| | 0 day | | 1st week | |
|---|---|---|---|---|
| Composition | 25° C. | 40 C. | 25° C. | 40° C. |
| 2.0% DV + | 9 × 10⁹ | 9 × 10⁹ | 9 × 10⁹ | 10 × 10⁹ |
| Rhizobium leguminosarum | | | | |
| 3.0% DV + | 10 × 10⁹ | 7 × 10⁹ | 8 × 10⁹ | 11 × 10⁹ |
| Rhizobium leguminosarum | | | | |
| Rhizobium leguminosarum | 10 × 10⁹ | 9 × 10⁹ | 7 × 10⁹ | 8 × 10⁹ |
| (without DV) | | | | |

DV—Dodonaea viscosa extract

From the table, it is evident that Rhizobium leguminosarum has stable viability when formulated with 2% and 3% D. viscosa extracts.

### Example 16: Viability of Bacillus megaterium with Dodonaea viscosa Extract

Bacillus megaterium was formulated with 0.5% Dodonaea viscosa extract and 5% Dodonaea viscosa extract and packed properly in sterile HDPE bottles and stored at ambient temperature (25° C.) and accelerated temperature (40° C.) in triplicates. Samples in triplicate are drawn at regular intervals for analysis. The viability of the strain in different temperatures are studied by serial dilution plating at 10⁷, 10⁸ and 10⁹ dilutions on agar media.

TABLE 17
Survivability of Bacillus megaterium with different concentrations of Dodonaea viscosa extract

| | 0 day | | 1^{st} week | | 2^{nd} week | | 3^{rd} week | |
|---|---|---|---|---|---|---|---|---|
| Composition | 25° C. | 40° C. | 25° C. | 40° C. | 25 C | 40° C. | 25° C. | 40° C. |
| 0.5% DV + | 9 × 10⁹ | 8 × 10⁹ | 9 × 10⁹ | 9 × 10⁹ | 10 × 10⁹ | 8 × 10⁹ | 11 × 10⁹ | 8 × 10⁹ |
| Bacillus megaterium | | | | | | | | |
| 5.0% DV + | 7 × 10⁹ | 8 × 10⁹ | 10 × 10⁹ | 9 × 10⁹ | 7 × 10⁹ | 8 × 10⁹ | 9 × 10⁹ | 7 × 10⁹ |
| Bacillus megaterium | | | | | | | | |
| Bacillus megaterium | 9 × 10⁹ | 10 × 10⁹ | 10 × 10⁹ | 9 × 10⁹ | 10 × 10⁹ | 9 × 10⁹ | 6 × 10⁹ | 6 × 10⁹ |
| (without DV) | | | | | | | | |

DV—Dodonaea viscosa extract

From the table, it is evident that Bacillus megaterium has stable viability upto 3 weeks when formulated with 0.5% and 5% D. viscosa extracts.

### ADVANTAGES OF THE PRESENT INVENTION

The present disclosure provides an agricultural composition that provides good plant growth, improved quality of product with higher yield.

The present disclosure provides an agricultural composition with reduced dosage of fertilizer.

The present disclosure provides an agricultural composition with improved stability and shelf-life.

The present disclosure provides an agricultural composition that is economical.

The present disclosure provides an agricultural composition that is safe for plants and environment.

The present disclosure provides an agricultural composition that is easy to prepare.

1. An agricultural composition comprising one or more agriculturally beneficial agents and an extract of a plant belonging to Dodonaea genus,
wherein the agriculturally beneficial agents are selected from the group consisting of agrochemical agents, biological agents, and combinations thereof;
the agrochemical agents are selected from the group consisting of an herbicide, a fungicide, an insecticide, a micronutrient, a fertilizer, and combinations thereof; and
the biological agents are selected from the group consisting of bacteria, mycorrhizal fungi, and a combination thereof.

2-4. (canceled)

5. The composition as claimed in claim 1, wherein the plant belonging to the Dodonaea genus is selected from the group consisting of Dodonaea triquetra, Dodonaea triangularis, Dodonaea lanceolata, Dodonaea serratifolia, Dodonaea trifida, Dodonaea bursariifolia, Dodonaea amblyophylla, Dodonaea humifusa, Dodonaea ceratocarpa, Dodonaea pinifolia, Dodonaea ericoides, Dodonaea ivaricata, Dodonaea caespitosa, Dodonaea tepperi, Dodonaea hexandra, Dodonaea stenophylla, Dodonaea pachyneura, Dodonaea rigidia, Dodonaea baueri, Dodonaea platyptera, Dodonaea adenophora, Dodonaea microzyga. Dodonaea polyzyga, Dodonaea physocarpa, Dodonaea madagascariensis, Dodonaea stenozyga, Dodonaea polyandra, Dodonaea concinna, Dodonaea larreoides, Dodonaea vestita, Dodonaea procumbens, Dodonaea biloba, Dodonaea viscosa, Dodonaea camfieldii, Dodonaea rupicola, Dodonaea boroniifolia, Dodonaea pinnata, Dodonaea multijuga, Dodonaea filiformis, Dodonaea macrossanii, Dodonaea oxyptera, Dodonaea falcata, Dodonaea peduncularis, Dodonaea filifolia, Dodonaea uncinata, Dodonaea hackettiana, Dodonaea coriacea, Dodonaea hirsuta, Dodonaea truncatiales, Dodonaea rhombifolia, Dodonaea megazyga, Dodonaea tenuifolia, Dodonaea heteromorpha, Dodonaea inaequifolia, Dodonaea ptarmicaefolia, Dodonaea lobulata, Dodonaea aptera, Dodonaea intricata, Dodonaea sinuolata, and combinations thereof.

6. The composition as claimed in claim 2, wherein the plant belonging to Dodonaea genus is Dodonaea viscosa.

7. The composition as claimed in claim 1, wherein the extract of the plant belonging to the Dodonaea genus is an aqueous extract.

8. The composition as claimed in claim 1, wherein the composition comprises the extract of the plant belonging to the Dodonaea genus in an amount ranging from about 0.1% to about 40% by weight of the composition.

9. The composition as claimed in claim 1, wherein the bacteria are selected from a group consisting of Actinomyces, Streptomyces, Mycobacterium, Nocardia, Corynebacterium, Streptococcus, Staphylococcus, Mycoplasma, Ureoplasma, Veillonella, Bacillus, Clostridium, Lactobacillus, Listeria, Rickettsia, Burkholderia, Escherichia, Pseudomonas, Legionella, Vibrio, Enterobacter, Stenotrophomonas, Azospirillum, Azovibrio, Polyangium, Ramlibacter, Rubrivivax, Sphingomonas, Rhizobium, Amycolatopsis, Pseudonocardia, Sphingomonas, Massilia, Methylobacterium, Bradyrhizobium, Bosea, Paenibacillus, Borrelia, Treponema, Leptospira, Gluconacetobacter, Azotobacter, and combinations thereof.

10. The composition as claimed in claim 6, wherein the bacteria are selected from a group consisting of Pseudomonas fluorescens, Pseudomonas putida, Bacillus subtilis, Bacillus amyloliquefaciens, Bacillus aryabhattai, Rhizobium leguminosarum, Azorhizobium caulidans, Fraturia aurentia, Bacillus megaterium, Bacillus amyloliquefaciens, Azotobacter chrococcum, Azospirilum lipoferum, Glucanoacetobacter diazotrophicus, Streptomyces viridochromogenes, Streptomyces hygroscopicus, Paenibacillus polymyxa, Streptomyces koyangenesis, Streptomyces iarkyus, and combinations thereof.

11. The composition as claimed in claim 1, wherein the mycorrhizal fungi comprise mycorrhizal propagules selected from the group consisting of propagules of endomycorrhiza, propagules of ectomycorrhiza, and combinations thereof.

12. The composition as claimed in claim 8, wherein the propagules of endomycorrhiza are selected from the group consisting of Glomus genera, Entrophospora, Funneliformis, Rhizophagus, Septoglomus, Acaulospora, Archaeospora, Paraglomus, Gigaspora, Pacispora, Sclerocystis, Dentiscutata, Scutellospora, and combinations thereof.

13. The composition as claimed in claim 8, wherein the propagules of ectomycorrhiza are selected from the group consisting of Laccaria, Pisolithus, Piriformospora, Scleroderma, Rhizopogon, and combinations thereof.

14. The composition as claimed in claim 1, wherein an amount of the bacteria in the composition ranges from about 0.1% to about 20% by weight of the composition.

15. The composition as claimed in claim 1, wherein an amount of the mycorrhizal fungi in the composition ranges from about 0.1% to about 90% by weight of the composition.

16. The composition as claimed in claim 1, wherein the agriculturally beneficial agent is mycorrhizal fungi, the composition further comprises bacterial endophytes selected from the group consisting of Enterobacter, Pseudomonas, Stenotrophomonas, Azospirillum, Azorhizobium, Azovibrio, Polyangium, Ramlibacter, Rubrivivax, Sphingomonas, Rhizobium, Streptomyces, Amycolatopsis, Fraturia, Pseudonocardia, Sphingomonas, Massilia, Methylobacterium, Bradyrhizobium, Bosea, Bacillus, Paenibacillus, Azotobacter, Gluconoacetobacter, and combinations thereof.

17. The composition as claimed in claim 1, wherein the composition further comprises one or more agriculturally acceptable excipient.

18. The composition as claimed in claim 1, wherein the composition further comprises a stabilizer.

19. The composition as claimed in claim 18, wherein the amount of the stabilizer in the composition ranges from 0.2% to about 80% by weight of the composition.

20-21. (canceled)

22. A method of improving plant health comprising applying to a plant, a plant propagation material, a site or medium of plant growth, or a locus, the agricultural composition of claim 1.

23. A method of treating a seed of a plant comprising applying to the seed the agricultural composition of claim 1.

24. (canceled)

25. A method of preparing an extract of a plant belonging to Dodonaea genus comprising:
A. grinding leaves, stems, roots and/or other parts of a plant belonging to Dodonaea genus into small particles, grains or a powder;
B. mixing the powder obtained in step A with a solvent and stirring to obtain a suspension;
C. adding a buffer salt mixture to the suspension obtained in step B;
D. centrifuging the suspension of step C and separating the supernatant to obtain the extract of the plant belonging to the Dodonaea genus.
